(19) United States
(12) Patent Application Publication
(10) Pub. No.: US 2013/0246851 A1
(43) Pub. Date: Sep. 19, 2013

(54) INFORMATION PROCESSING APPARATUS, A SENDER APPARATUS AND A CONTROL METHOD OF THE INFORMATION PROCESSING APPARATUS

(71) Applicant: FUJITSU LIMITED, Kawasaki-shi (JP)

(72) Inventor: Yoshitsugu Goto, Kawasaki (JP)

(73) Assignee: FUJITSU LIMITED, Kawasaki-shi (JP)

(21) Appl. No.: 13/893,451

(22) Filed: May 14, 2013

Related U.S. Application Data
(63) Continuation of application No. PCT/JP2010/070375, filed on Nov. 16, 2010.

(51) Int. Cl. G06F 11/07

(52) U.S. Cl. CPC G06F 11/0751
USPC 714/32

(57) ABSTRACT

An information processing apparatus may include a sender apparatus and a receiver apparatus connected to the sender apparatus. The sender apparatus includes a processor configured to output a plurality of output signals, a counter configured to send a report indicating that a predetermined time has been counted, and a pseudofault generator configured to change a value of any one of the output signals output by the processor based on the report sent from the counter. The receiver apparatus includes an error detector configured to detect an error with respect to the changed value of the one of the output signals output by the processor.

### CROSS-REFERENCE TO RELATED APPLICATIONS

The present application is a U.S. continuation application filed under 35 USC 111(a) claiming benefit under 35 U.S.C. 120 and 365(c) of PCT International Application No. PCT/JP2010/070375 filed on Nov. 16, 2010, the entire contents of which are incorporated herein by reference.

### FIELD

The disclosures herein are related to an information processing apparatus, a sender apparatus and a control method of the information processing apparatus.

### BACKGROUND

There is known in the art a method of causing a pseudofault by injecting an error into a functional unit of a large scale integrated circuit (LSI) such as a processor. In the above method, instructions relating to types of testing errors and types of errors injected into an error injecting circuit of a system are given to the system utilizing a joint test action group (JTAG) interface (IF) defined by the Institute of Electrical and Electronics Engineers, Inc. 1149.1 (IEEE 1149.1).

Further, there is a pseudofailure causing circuit known in the art. The pseudofailure causing circuit includes an output signal line of a decoder connected to a part in which the pseudofault is caused, and a register configured to set data serially so that a pseudofailure may be caused in a desired part at a desired timing.

In addition, there is known in the art a pseudofailure causing mechanism that enables the pseudofailure to be caused at a desired time by setting pseudofailure causing timing to a timer to output a signal according to a level corresponding to one of a fixed failure that is a once caused failure being constantly fixed or an intermittent failure that is a failure caused intermittently.

Moreover, there is known in the art a constraint error causing circuit for testing an error detection function of a data processing apparatus. The constraint error generating circuit is configured to generate a signal designating a component within a data processing apparatus generating a constraint error and a signal designating a constraint error generation period so as to generate an error forcibly to test the error detection function.

Further, there is known in the art a pseudodisk apparatus for causing a pseudoerror, which includes an error data register to which a service processor managing an information processing apparatus sets an error content and an error address resister.

In addition, various examples of a pseudofailure testing method of the information processing apparatus are disclosed as follows. Such a pseudofailure testing method tests a pseudofailure function of the information processing apparatus by reading error log information from an external storage device based on a set of instructions from a pseudofailure testing program, and analyzing two sets of the error log information that are read before and after the execution of the pseudofailure testing program.

### RELATED ART DOCUMENTS

### Patent Document

Patent Document 1: Japanese Laid-open Patent Publication No. 2007-200300
Patent Document 2: Japanese Laid-open Patent Publication No. 62-271155
Patent Document 3: Japanese Laid-open Patent Publication No. 3-184133
Patent Document 4: Japanese Laid-open Patent Publication No. 62-111331
Patent Document 5: Japanese Laid-open Patent Publication No. 56-88550
Patent Document 6: Japanese Laid-open Patent Publication No. 5-20115
Patent Document 7: Japanese Laid-open Patent Publication No. 2006-53043

### SUMMARY

According to one aspect of the present invention, an information processing apparatus may include a sender apparatus and a receiver apparatus connected to the sender apparatus. In the information processing apparatus, the sender apparatus includes a processor configured to output a plurality of output signals; a counter configured to send a report indicating that a predetermined time has been counted; and a pseudofault generator configured to change a value of any one of the output signals output by the processor based on the report sent from the counter. Further, in the information processing apparatus, the receiver apparatus includes an error detector configured to detect an error with respect to the changed value of the one of the output signals output by the processor.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a block diagram illustrating an example of a pseudofault causing method;

FIG. 2 is a flowchart illustrating an operational flow of the example of the pseudofault causing method illustrated in FIG. 1;

FIG. 3A is a flowchart illustrating an operational flow of a pseudofault causing method according to a first embodiment;

FIG. 3B is a diagram illustrating an error process flow in the pseudofault causing method according to the first embodiment illustrated in FIG. 3A;

FIG. 4 is a diagram illustrating a configuration example of an information processing apparatus to which the pseudofault causing method according to the first embodiment illustrated in FIG. 3A is applied;

FIG. 5 is a diagram illustrating a configuration example of a pseudofault register for use in the pseudofault causing method according to the first embodiment illustrated in FIG. 3A;

FIG. 6 is a diagram illustrating a configuration example of an information processing apparatus to which a pseudofault causing method according to a second embodiment is applied;

FIG. 7 is a diagram illustrating a configuration example of a pseudofault register for use in the pseudofault causing method according to the second embodiment;

FIG. 8 is a diagram illustrating a circuit configuration example of a timer control circuit in association with FIG. 6;

FIG. 9 is a timing chart illustrating an example of an operational flow of the timer control circuit in association with FIG. 8;

FIG. 10 is a diagram illustrating a configuration example of a pseudofault register for use in a pseudofault causing method according to a third embodiment;

FIG. 11 is a diagram illustrating a circuit configuration example of a timer control circuit for use in the pseudofault causing method according to the third embodiment;

FIG. 12 is a timing chart illustrating an example of an operational flow of the timer control circuit illustrated in FIG. 11;

FIG. 13 is a diagram illustrating a configuration example of an information processing apparatus implementing the pseudofault causing method according to the third embodiment;

FIG. 14 is a diagram illustrating a configuration example of an information processing apparatus implementing a pseudofault causing method according to a fourth embodiment;

FIG. 15 is a flowchart illustrating an example of an operational flow of the pseudofault causing method according to the fourth embodiment;

FIG. 16 is a diagram illustrating a circuit configuration example of a clock signal distributor (CD) illustrated in FIG. 14; and

FIG. 17 is a timing chart illustrating an example of an operational flow of the CD illustrated in FIG. 16.

### DESCRIPTION OF EMBODIMENTS

Preferred embodiments of the present invention will be described with reference to the accompanying drawings. Those parts and the like that are the same are designated by the same reference numerals, and a description thereof will be omitted.

The embodiments may provide a configuration capable of effectively setting various modes or conditions to generate a pseudofailure signal in an information processing apparatus.

According to the embodiments, a pseudofailure is caused in a configuration having an electrically coupled interval between semiconductor devices installed on a printed circuit board such as a system board included in the information processing apparatus, or in a configuration having an electrically coupled interval between various components. Specifically, an information processing apparatus according to the embodiments may fix to a predetermined level a specific signal output from a semiconductor device or a component of a sender, or a specific signal input into a semiconductor device or a component of a receiver while the information processing apparatus is operating. Or the information processing apparatus according to the embodiments may cause a pseudofault by fluctuating the level of such a signal intermittently or in a fixed manner. Note that a pseudofault indicates a fault caused by deliberately maneuvering a signal for the purpose of verifying whether a RAS (reliability, availability and serviceability) function of an error detection circuit or error correction circuit appropriately detects or corrects an abnormal signal. Note the RAS function may improve the reliability, the availability and the serviceability by detecting or correcting an error. Further, according to the embodiments, various modes or conditions to cause a pseudofault such as intermittent fault causing intervals may be set. Further, the embodiments provide a configuration to point out or specify an abnormality detected part or an abnormality detected component when the above RAS function detects an abnormal signal generated by causing the pseudofault.

An example of a testing support tool for causing a pseudofault for a test of a printed circuit board contained in an information processing apparatus may include a black box clip (BBC) tester, for example. In the printed circuit board test utilizing the BBC tester, a probe of the BBC tester is brought into contact with a via-hole of surface layer wiring on a soldering surface of the printed circuit board to clip the via-hole at 0 V, thereby causing the pseudofault in the printed circuit board. Then, whether the pseudofault caused in the printed circuit board is appropriately treated by the RAS function contained in the information processing apparatus is verified in the printed circuit board test. The above-described test to cause a pseudofault in order to verify whether the caused pseudofault is appropriately treated is called a “pseudofault test”.

The purpose of verifying the RAS function with the pseudofault is as follows. When a fault actually occurs in an operating information processing apparatus after shipping of the above information processing apparatus, it is preferable to obviate a situation in which a data error resulting from the fault is inappropriately detected or corrected, or the RAS function fails to detect a broken part (a subject component having a fault) appropriately. The pseudofault test may be mainly employed in a system evaluation test.

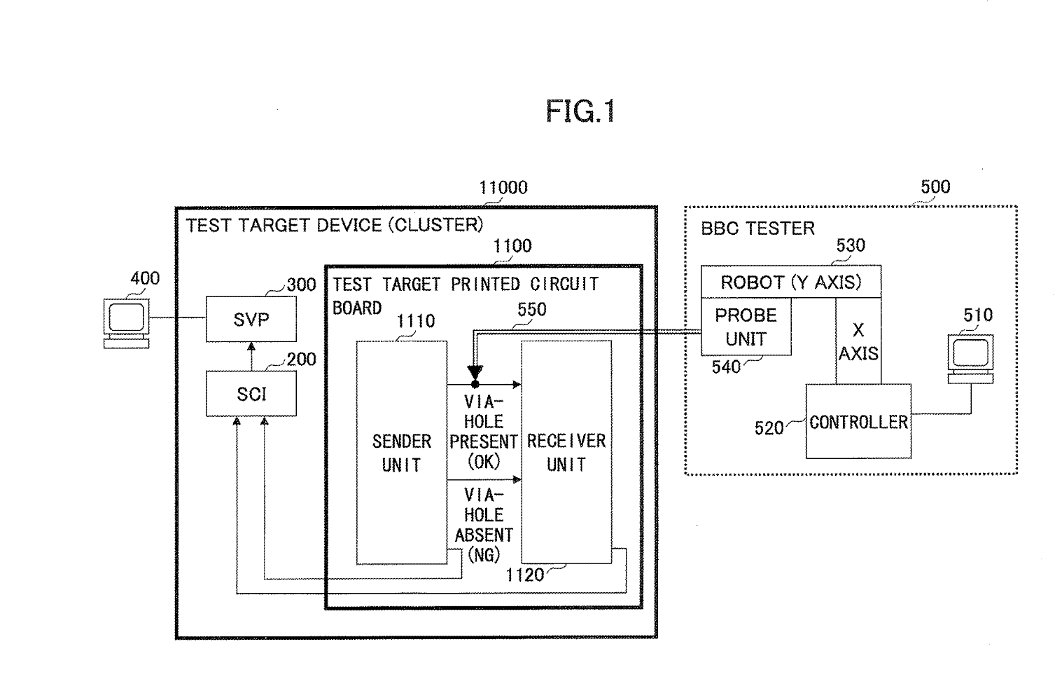

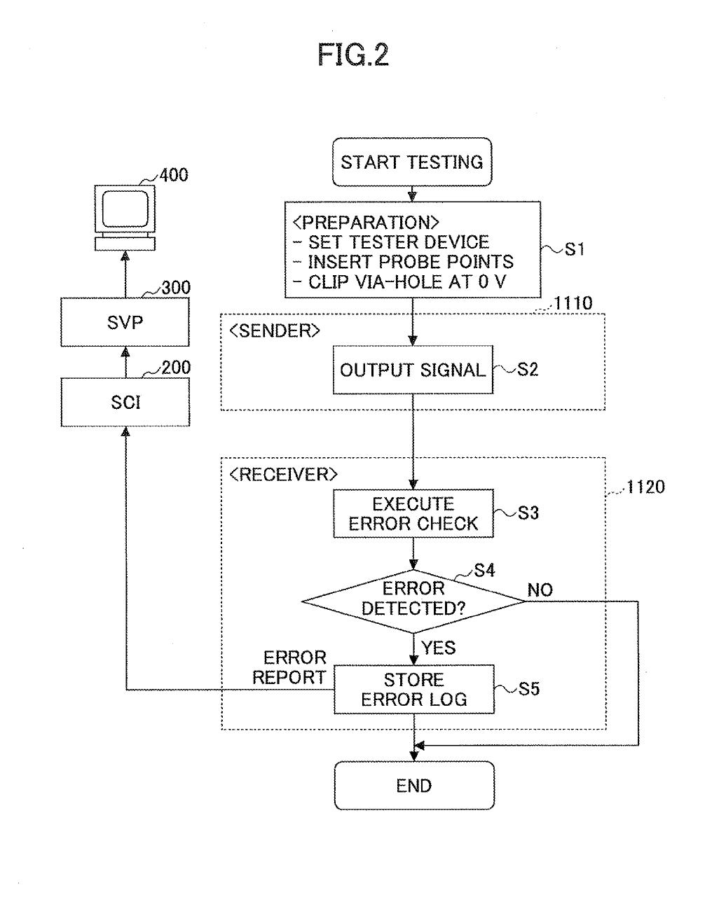

Next, a specific example of the pseudofault test utilizing the BBC tester is illustrated with reference to FIGS. 1 and 2. FIG. 1 illustrates an information processing apparatus 11000 serving as a testing target apparatus and a BBC tester 500. The information processing apparatus 11000 includes a testing target printed circuit board 1100 such as a system board, a system console interface (SCI) 200, and a service processor (SVP) 300. The testing target printed circuit board 1100 includes a configuration having a sender unit 1110 composed of a semiconductor device of a sender and a receiver unit 1120 composed of a semiconductor device of a receiver on the printed circuit board 1100. The SVP 300 serves as a processor having a monitoring function to monitor operations of the testing target printed circuit board 1100. The SVP 300 is connected to a console 400, which is used for displaying an analysis result of the SVP 300 or inputting contents of instructions addressed to the SVP 300. The serial communication interface (SCI) is devised based on a Joint Test Action Group (JTAG) standard that is in compliance with the IEEE 1149.1 Standard.

The BBC tester 500 includes a probe unit 540 configured to drive an arm 550 having the probe configured to be brought into contact with a via-hole of the surface layer wiring on the soldering surface of the printed circuit board 1100, and a robot 530 configured to drive the probe unit 540 in X axis and Y axis directions. The BBC tester 500 further includes a controller 520 configured to control the probe unit 540 and the robot 530, and a personal computer (PC) 510.

In the pseudofault test utilizing the BBC tester 500, positional information of a via-hole on the soldering surface of the testing target printed circuit board 1100 is input from the PC 510 to the controller 520. In response to the input of the positional information of the via-hole, the controller 520 controls the robot 530 for maneuvering the arm 550, and locates the probe on a pointed end of the arm 550 in the via-hole of the surface layer wiring on the soldering surface of the testing target printed circuit board 1100 indicated by the positional information. The probe on the pointed end of the arm 550 is thus grounded by being brought into contact with the via-hole of the surface layer wiring on the soldering surface of the testing target printed circuit board 1100 to forcibly set a signal potential of the surface layer wiring at 0 V, thereby causing the pseudofault.

Next, an operational flow of the pseudofault test is illustrated with reference to FIG. 2. When starting the pseudofault test, step S1 is conducted as preparation. In step S1, a predetermined positional relationship is set between the BBC tester 500 and the testing target printed circuit board 1100 of the information processing apparatus 11000 and probe points are inserted in the via-hole of the above surface layer wiring. Then, the BBC tester 500 clips the via-hole at 0V. Next, signals including a signal flowing in the via-hole are output from the sender unit 110 to the receiver unit 1120 of the testing target printed circuit board 1100 (step S2). Note that as described above, since the BBC tester 500 clips the via-hole at 0 V, a pseudofault is caused in the above signals. In the sender unit 1120, when an error check function (step S3) detects the pseudofault (“YES” in step S4), a corresponding error log is stored (step S5), and an error is reported to the SVP 300 via the SCI 200. The SVP 300 analyzes the reported error and displays an analysis result on a screen of the console 400. An operator verifies the RAS function by monitoring the screen 400 of the console 400 to determine whether a signal of the surface layer wiring corresponding to the via-hole clipped at 0 V by the BBC tester 500 is appropriately displayed as a fault part.

The pseudofault test utilizing the BBC tester 500 illustrated with reference to FIGS. 1 and 2 may need to be considered in terms of the following points.

a) The via-hole may need to be clipped at 0 V. Hence, when there is no via-hole of the surface layer wiring on the soldering surface of the testing target printed circuit board, the probe may be unable to come into contact with the via-hole for a signal of the surface layer wiring. As a result, the via-hole is not clipped at 0 V, or a via-hole of the surface layer wiring that is hidden by a component is not clipped at 0 V. In the above cases, it may be difficult to cause a pseudofault corresponding to a desired signal.

b) The height of some component implemented on the printed circuit board or the size of the printed circuit board will not allow the arm 550 of the BBC tester 500 to approach a desired via-hole. As a result, the desired via-hole may be unable to be clipped at 0 V.

c) Since the via-hole is clipped at 0 V (grounded), it may be unable to cause a pseudofault that fixes a signal indicating a 0 V representing an activating (assert) status to a (deactivating) negate status.

d) In the pseudofault test being conduced at a system power-on state, even if the via-hole is clipped at 0 V before the operation of a desired signal in the sender unit, the 0 V is not detected as a fault due to the fact that the desired signal is simply before the operation in the receiver unit. Thus, it may be unable to cause the pseudofault.

e) In a case of the pseudofault caused in the component having an error monitoring condition, it may be difficult to clip the via-hole at 0 V in a type of causing the pseudofault that matches the error monitoring condition. The error monitoring status condition indicates a monitoring status having such as a threshold of durable time and a threshold of the number of times a pseudofault is caused.

The following embodiments may enable a desired pseudofault status to be caused corresponding to a specific signal by disposing a pseudofault causing circuit logic circuit serving as hardware. As a result, the RAS function may be effectively verified (tested) by setting various modes or conditions to cause pseudofault.

### First Embodiment

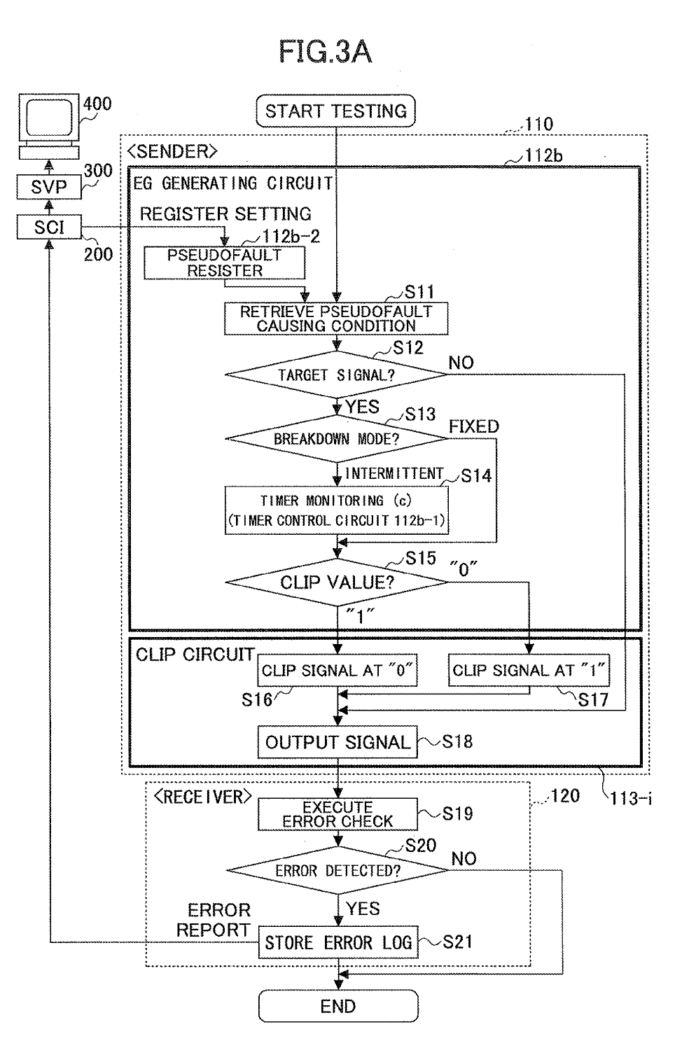

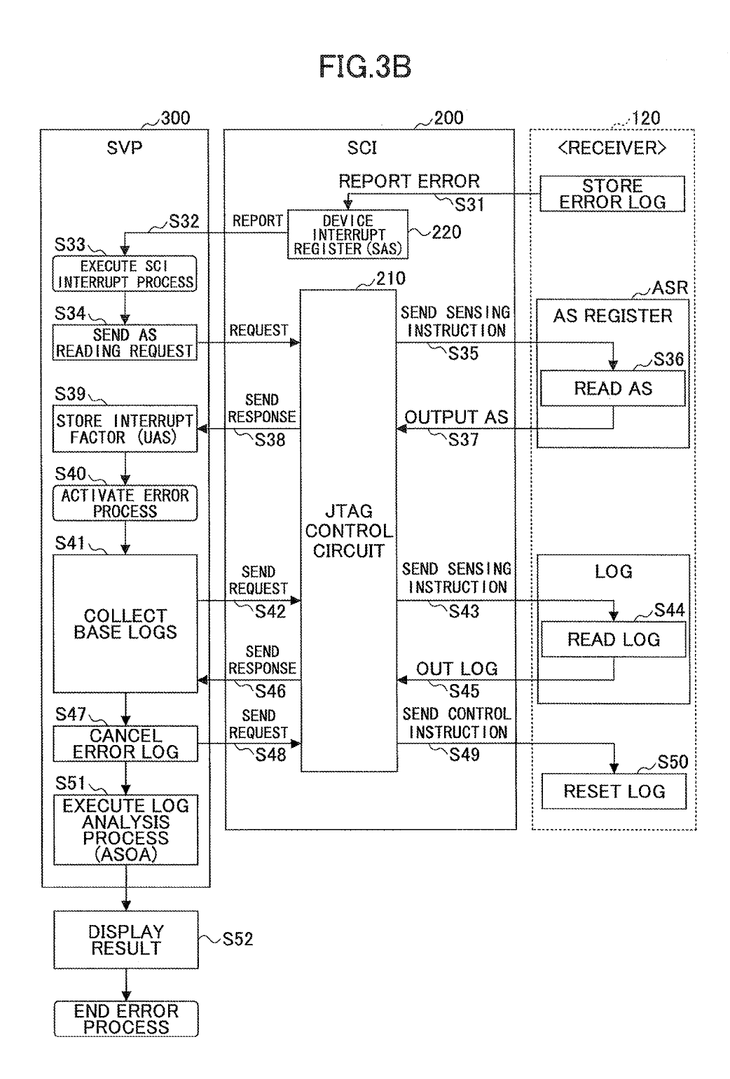

A description is given of an operational flow of a pseudofault causing method according to a first embodiment with reference to FIG. 3A. A printed circuit board serving as the testing target printed circuit board 1100 having a configuration, in which the sender unit 110 and the receiver unit 120 are connected to each other, is provided with an EG generating circuit 112b for causing a pseudofault inside the sender unit 110. The EG generating circuit 112b includes a configured to allow an SCI 200 to set a pseudofault causing condition, and a timer control circuit 112b-1 configured to control intermittently causing intervals for causing the pseudofault.

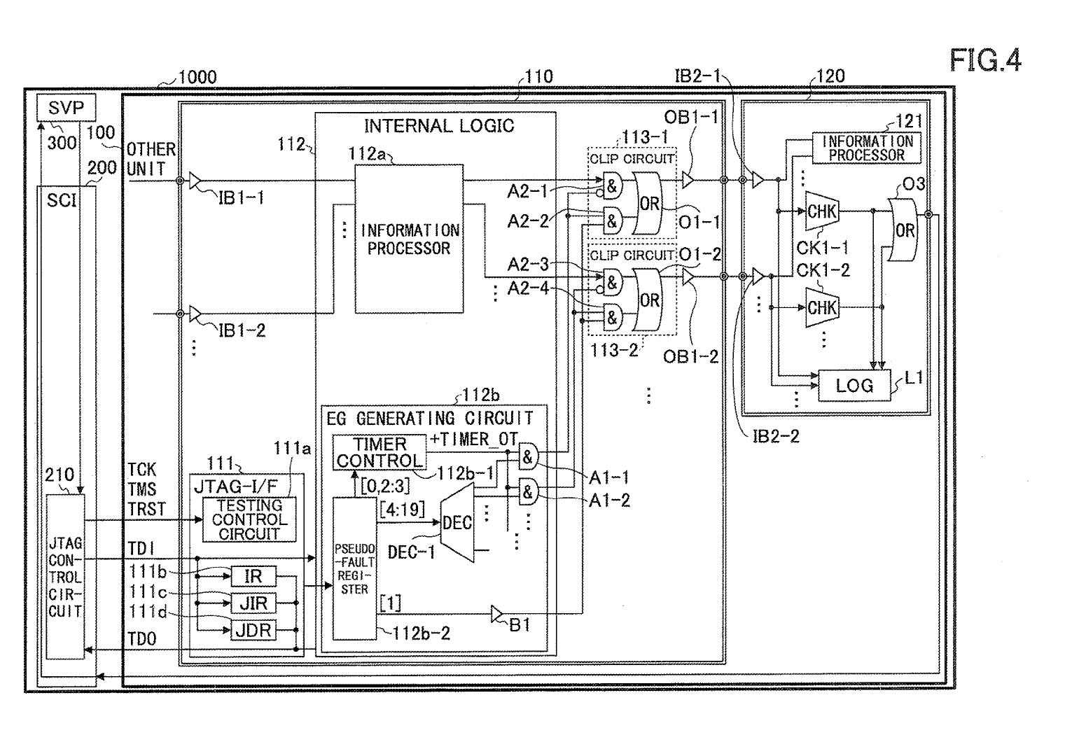

In FIG. 3A, the pseudofault causing condition is retrieved from the pseudofault register 112b-2 (step S11). Note that a later-described step S18 is executed for a signal mismatching a subject signal, corresponding to which a pseudofault is caused, contained in the pseudofault causing condition retrieved in step S11. In step S18, an information processor 112a (later-described with reference to FIG. 4) configured to perform an ordinary information process within the sender unit 110 outputs a signal for the signal mismatching the subject signal corresponding to which a pseudofault is caused; that is, the information processor 112a outputs a signal per signal other than the subject signal.

On the other hand, step S13 is executed for a signal matching the subject signal corresponding to which the pseudofault is caused. In step S13, whether a pseudofault causing mode contained in the pseudofault causing condition retrieved in step S11 is a “fixed” mode, in which the pseudofault is constantly caused, or an “intermittent” mode, in which the pseudofault is intermittently caused, is determined. When the pseudofault causing mode is the “fixed” mode, step S15 is executed, whereas when the pseudofault causing mode is the “intermittent” mode, step S14 is executed.

In step S15, whether a clip value contained in the retrieved pseudofault causing condition is “0” or “1” is determined. When the clip value is “0”, corresponding clip circuits 113-1, 113-2, . . . (later-described with reference to FIG. 4) clip the subject signal at “0”. On the other hand, when the clip value is “1”, the corresponding clip circuits 113-1, 113-2, . . . clip the subject signal at “1”. Note that when step S14 is not executed (skipped), the subject signal is clipped at “0” in a fixed manner in step S16, and the subject signal is clipped at “1” in a fixed manner in step S17. On the other hand, when step S14 is executed, the subject signal is intermittently clipped at “0” in step S16, and the subject signal is intermittently clipped at “1” in step S17.

When the signal is clipped in step S16 or S17, a signal of the set clip value is output in step S18 based on whether step S14 is executed. Accordingly, when step S14 is not executed (skipped), a signal representing “0” is output as the subject signal in a fixed manner in step S16, and a signal representing “1” is output as the subject signal in a fixed manner in step S17. On the other hand, when step S14 is executed, a signal representing “0” is intermittently output as the subject signal in step S16, and a signal representing “1” is intermittently output as the subject signal in step S17. Note that when the signal representing “0” is intermittently output, the information processor 112a outputs a signal during a time other than the time where the signal representing “0” is output or the signal representing “0” is clipped. Similarly, when the signal representing “1” is intermittently output, the information processor 112a outputs a signal during a time other than the time where the signal representing “1” is output or the signal representing “1” is clipped.

In step S19, the receiver unit 120 receives the signal output from the sender unit 110 in step S18, and performs on the received signal a parity check, a error check and correction check (ECC), a cyclic redundancy check (CRC), or the like. When an error is not detected as a result of the error check (“NO” in step S20), the testing process is ended, whereas when an error is detected (“YES” in step S20), step S21 is executed. In step S21, the receiver unit 120 stores a log associated with the detected error. The log associated with the stored error (hereinafter called an “error log”) is reported to the SVP 300 via the SCI 200, and the SVP 300 analyzes the error log and displays an analysis result on a screen of a console 400. The operator monitors the analysis result displayed on the screen of the console 400, and verifies the RAS function by determining whether a fault part designated by the pseudofault causing condition set via the SCI 200 to the pseudofault register 112b-2 of the sender unit 110 is correctly displayed.

Next, a detailed illustration is given of an operational example in which the error log stored in the receiver unit 120 in step S21 illustrated in FIG. 3A is reported to the SVP 300 via SCI 200, and the SVP analyzes the error log.

The SCI 200 in FIG. 38 includes a system active state register (SAS) 220. When the SCI 200 receives an error generated report (interrupt) from the receiver unit 120, the SAS 220 stores the error generated report (step S31). The error generated report stored in the SAS 220 is sent to the SVP 300 (step S32), and the SVP 300 starts executing an interrupt process on receiving the error generated report (step S33).

When the SVP 300 starts executing the interrupt process in step S33, the SVP 300 sends an AS reading request for requesting the SCI 200 to read an error factor from an active state (AS) register ASR in which the error factor is associated with the error generation (step S34). A JTAG control circuit 210 of the SCI 200 receives the AS reading request and executes the AS reading request to read the error factor associated with the error generation from an AS register ASR in the receiver unit 120 as a JTAG sensing instruction for sensing the content of the AS register ASR.

Having received the AS reading request, the receiver unit 120 reads the error factor associated with the error generation from the AS register ASR and sends the read error factor to the SCI 200 (steps S36 and S37). On receiving the error factor, the JTAG control circuit 210 of the SCI 200 sends the received error factor to the SVP 300 (step S38). The SVP 300 stores the received error factor in a unit active state register (UAS) (step S39) to activate an error process associated with the error factor (step S40).

In the error process (step S40), the SVP 300 collects error logs associated with the error factor (step S41). Specifically, the SVP 300 sends an error log collecting request associated with the error factor to the JTAG control circuit 210 of the SCI 200 (step S42). On receiving the error log collecting request, the JTAG control circuit 210 sends a JTAG sensing instruction serving as an error log collecting instruction associated with the error factor to the receiver unit 120 (step S43). On receiving the JTAG sensing instruction, the receiver unit 120 reads the error logs (step S44), and sends the read error logs to the JTAG control circuit 210 (step S45). On receiving the error logs, the JTAG control circuit 210 of the SCI 200 sends the received error logs to the SVP 300 (step S46).

On receiving the error logs, the SVP 300 sends an error log reset request for initializing the error logs (steps S47 and S48) to the JTAG control circuit 210 such that the error log reset request is sent to the receiver unit 120 via the JTAG control circuit 210 (step S49). On receiving the error reset request (a control instruction), the sender unit 120 initializes the corresponding error logs (step S50).

Next, the SVP 300 stores the error logs received in step S46 as base logs serving as the basis of a failure analysis, and executes a failure analysis program (i.e., an auto scan-out analysis ASOA) based on region code (RC) information serving as error information representing a hardware failing part contained in the stored base logs (step S51). The SVP 300 specifies the hardware failing part based on the RC information contained in the base logs and displays an error analysis result including the hardware failing part on the screen of the console 400 (step S52).

Next, a description is given of a configuration of an information processing apparatus 1000 that implements a pseudofault causing method according to the first embodiment with reference to FIG. 4. The information processing apparatus 1000 includes a testing target printed circuit board 100 such as a system board, a system console interface (SCI) 200, and a service processor (SVP) 300. The testing target printed circuit board 100 includes a sender unit 110 and a receiver unit 120. The sender unit 110 includes an information processor 112a configured to perform an information process and send data as a result of the information process to the receiver unit 120. The receiver unit 120 includes an information processor 121 configured to perform an information process based on the data serving as the result of the information process sent from the sender unit 110.

The sender unit 110 is configured to execute a test in compliance with the IEEE standards compliant JTAG standards scanning system. The sender unit 110 receives from the JTAG control circuit 210 of the SCI 200 an instruction to read or write instructions or data used for the test in compliance with the JTAG standards scanning system. More specifically, the JTAG control circuit 210 of the SCI 200 performs the following operations in response to the JTAG sensing instruction from the SVP 300. That is, the JTAG control circuit 210 of the SCI 200 sends to the sender unit 110 via a JTAG-interface (JTAG-IF) 111 an instruction to sense the content of the internal register (i.e., the pseudofault register 112b-2, etc.).

The JTAG-IF 111 includes a testing control circuit 111a, an instruction register (IR) 111b, a JTAG instruction register (JIR) 111c, and a JTAG data register (JDR) 111d. In the JTAG-IF 111, each of the states of a JTAG compliant state machine transitions according to a corresponding one of states indicated by signals TMS (test mode select), TCK (test clock), and TRST (test request) received by a test access port (TAP) of the testing control circuit 111a. Then, instructions and data are set to the above-described IR 111b, JIR 111c, and JDR 111d so that the JTAG sensing instructions and JTAG control instructions are executed according to the corresponding set instructions and data.

A description is given below of signals (i.e., interface signals) TCK (test clock), TMS (test mode select), and TDI (test data input) that allow JTAG control circuit 210 of the SCI 200 to give instructions to the sender unit 110. A test clock (TCK) is a clock signal supplied to the testing control circuit 111a contained in the JTAG-IF 111. A test mode select (TMS) is an enabling signal to enable the testing control circuit 111a contained in the JTAG-IF 111, and sampled at rising time of the TCK. The TDI (test data input) is a signal to set an instruction to the IR 111b of the JTAG-IF 111 by scan shifting, or to set data to the JIR 111c or JDR 111d by scan shifting.

Note that in the IR 111b, an instruction code is set. The instruction code indicates selecting one of the JIR 111c and JDR 111d, when executing the JTAG control instruction which serves as the JTAG sensing instruction or other control instructions. In the JIR 111c, a command is set when executing the JTAG sensing instruction or other control instructions. The command indicates selecting one of the registers defined in the internal logic (arithmetic-logic unit) 112. Data to be written into the register selected in the JIR 111c are set to the JDR 111d by scan shifting when executing the JTAG control instruction. On the other hand, data to be read from the register are set to the JDR 111d by scan shifting when executing the JTAG sensing instruction. The read data are read from the JDR 111d via a TDO (test data output) and transferred to the JTAG control circuit 210 of the SCI 200.

Further, the TDO (test data output) is a terminal to output the instruction code set to the IR 111b of the JTAG-IF 111 by scan shifting, or to output the data set to the JIR 111c or JDR 111d by scan shifting. The TRST (test request) is a signal to reset the testing control circuit 111a.

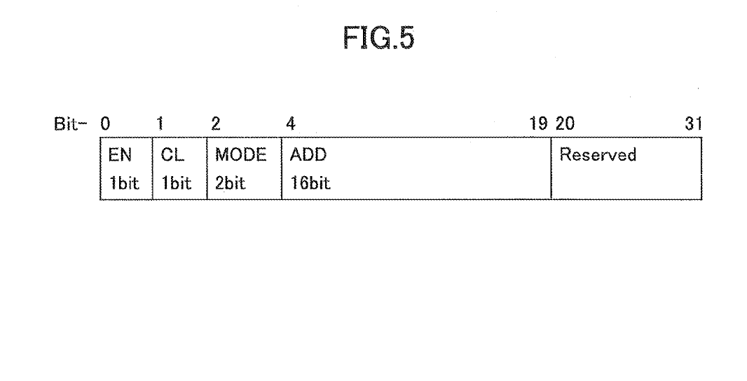

The internal logic 112 of the sender unit 110 includes the EG generating circuit 112b. The EG generating circuit 112b may include the aforementioned pseudofault register 112b-2 having, for example, a 4-byte configuration, a timer control circuit 112b-1 to control intermittent fault causing intervals, and a decoder circuit DEC-1. As described above, the pseudofault causing condition is thus set to the pseudofault register 112b-2 from the SCI 200 via the JTAG-IF 111. FIG. 5 illustrates a configuration example of the pseudofault register 112b-2.

In the configuration example of the pseudofault register 112b-2 illustrated in FIG. 5, Bit(0) represents an enable bit (EN), Bit(1) represents a clip bit (CL) indicating a clip value, and 2 bits of Bit(2:3) represent a fault mode bit (MODE) indicating a fault mode. Sixteen bits of Bit(4:19) represent an address bit (ADD) indicating an address designating a terminal (the maximum of 65536 pins) outputting a signal causing a pseudofault.

More specifically, when a pseudofault is to be caused, “1” is set to the EN bit, whereas when a pseudofault is not to be caused, “0” is set to the EN bit. That is, when “0” is set to the EN bit, values in the fields other than that of the EN bit are ignored. When data are clipped at “1” as a pseudofault, “1” is set to the CL bit indicating the clip value, whereas when data are clipped as “0”, “0” is set to the CL bit. When data are clipped as a pseudofault in a fixed manner, “11” is set to the MODE bit as the fault mode (MODE), whereas when data are intermittently clipped, “10” or “01” is set to the MODE bit. Further, when data are intermittently clipped and 100 μs is set as clip duration for each clip, “10” is set to the fault mode bit (MODE), whereas when 10 μs is set as the clip duration for each clip, “01” is set to the fault mode bit (MODE).

The EG generating circuit 112b includes AND circuits A1-1, A1-2, . . . , the number of which corresponds to the number of output terminals of the sender unit 110. The decode circuit DEC-1 is configured to output “1” to each of the AND circuits connected to the output terminals that exhibit a pseudofault according to the settings of ADD fields of the pseudofault register 112b-2. The decode circuit DEC-1 is further configured to output “0” to each of the AND circuits connected to the output terminals that do not exhibit the pseudofault. The timer control circuit 112b-1 is configured to output “1” during a data clip period when the EN bit is “1” according to the settings of the EN bit and the MODE field of the pseudofault register 112b-2. As a result, those subject to causing the pseudofault among the AND circuits A1-1, A1-2, . . . to which “1” is input from the decoder circuit DEC-1 output “1” while the timer control circuit 112b-1 outputs “1”. On the other hand, those subject to causing the pseudofault among the AND circuits A1-1, A1-2, . . . to which “0” is input from the decoder circuit DEC-1 output “0”.

Further, the sender unit 110 includes clip circuits 113-1, 113-2, . . . , the number of which corresponds to the number of output signals of the information processor 112a, that is, the number of output terminals of the information processor 112a. In addition, the output terminals of the clip circuits 113-1, 113-2, . . . are connected to the output terminals of the sender unit 110 via buffers OB1-1, OB1-2, . . . , respectively. The output terminals of the sender unit 110 are connected to counterpart input terminals of the receiver unit 120 via the wiring on the printed circuit board 100.

The input terminals of the receiver unit 120 are connected via buffers IB1-, IB1-2, . . . to error check circuits CK1-1, CK1-2, . . . , respectively, as well as being connected to the information processor 121. The error check circuits CK1-1, CK1-2, . . . perform the error check operation in step S3 illustrated in FIG. 2 for every received signal. When an error is detected (“YES” in step S4 in FIG. 2) as a result of the error check operation, the content of the error log is reported to the SCI 200 via an OR circuit O3 while the content of the detected error is stored as an error log in a storage device L1 (step S5 in FIG. 2). The SCI 200 sends the content of the error log to the SVP 300.

In addition, each of the clip circuits 113-1, 113-2, . . . include respective two AND circuits (A2-1 and A2-2, A2-3 and A2-4, and respective one OR circuit (O1-1, O1-2, In each of the clip circuits 113-1, 113-2, . . . , the output terminals of the two AND circuits are connected to the input terminals of the OR circuit. One of the input terminals of each of the first AND circuits (i.e., A2-1, A2-3, of the clip circuits 113-1, 113-2, . . . is connected to a counterpart one of output terminals of the information processor 112a.

The output terminals of the AND circuits A1-1, A1-2, . . . of the EG generating circuit 112b are connected to the other input terminals of the first AND circuits A2-1, A2-3, . . . of the counterpart clip circuits 113-1, 113-2, . . . , respectively, via inverter circuits (each represented by a circle in FIG. 4). The output terminals of the AND circuits A1-1, A1-2, . . . of the EG generating circuit 112b are further connected to the input terminals of the second AND circuits A2-2, A2-4, . . . of the counterpart clip circuits 113-1, 113-2, . . . , respectively. Further, the pseudofault register 112b-2 indicating a value of a CL bit is connected to the other input terminals of the second AND circuits A2-2, A2-4, . . . of the clip circuits 113-1, 113-2, . . . via a buffer B1.

As a result, among the clip circuits 113-1, 113-2, . . . , those subject to causing the pseudofault to which “1” is input from the decoder circuit DEC-1 may perform the following operations. That is, when the value of the CL bit of the pseudofault register 112b-2 is “1”, “1” is input to the other input terminals of the second AND circuits A2-2, A2-4, . . . . Accordingly, the second AND circuits A2-2, A2-4, . . . associated with the pseudofault cause signal output “1” during a clip period where “1” is output from the timer control circuit 112b-1. On the other hand, the second AND circuits A2-2, A2-4, . . . output “0” during a period where “0” is output from the timer control circuit 112b-1. As a result, the OR circuits O1-1, O1-2, . . . of the clip circuits 113-1, 113-2, . . . subject to causing the pseudofault to which “1” is input from the decoder circuit DEC-1 output “1” during the clip period where the timer control circuit 112b-1 outputs “1”. On the other hand, the corresponding first AND circuits A2-1, A2-3, . . . output “0” during anon-clip period where “0” is output from the timer control circuit 112b-1.

By contrast, “0” is input to the other input terminals of the first AND circuits A2-1, A2-3, . . . of the clip circuits 113-1, 113-2, . . . subject to causing the pseudofault during the clip period where “1” is output from the timer control circuit 112b-1. On the other hand, “1” is input to the other input terminals of the first AND circuits A2-1, A2-3, . . . of the clip circuits during the non-clip period where “0” is output from the timer control circuit 112b-1. Accordingly, the first AND circuits A2-1, A2-3, . . . of the clip circuits 113-1, 113-2, . . . are subject to causing the pseudofault to output the output data of the information processor 112a during the non-clip period, and output “0” during the clip period.

As a result, the OR circuits O1-1, O1-2, . . . of the clip circuits 113-1, 113-2, . . . are subject to causing the pseudofault to output “1” during the clip period where the timer control circuit 112b-1 outputs “1”. On the other hand, the OR circuits O1-1, O1-2, . . . of the clip circuits output the output data of the information processor 112a during the non-clip period where the timer control circuit 112b-1 outputs “0”. Accordingly, when the data are configured to be clipped at “1” as the pseudofault (i.e., CL=“1”), those subject to causing the pseudofault to which “1” is input from the decoder circuit DEC-1 among the clip circuits 113-1, 113-2, . . . may output the following data. That is, the OR circuits O1-1, O1-2, . . . of the clip circuits output “1” during the clip period whereas the OR circuits O1-1, O1-2, . . . of the clip circuits output the output data of the information processor 112a during the non-clip period. Hence, in this case, the corresponding signal is clipped at “1” only during the clip period, the output data of the information processor 112a in a normal system operation are output during a period other than the clip period.

Next, a description is given of a case where the data are clipped at “0” (i.e., CL=“0”) as a pseudofault. In this case, “0” is input to the other input terminals of the second AND circuits A2-2, A2-4, . . . of the respective clip circuits 113-1, 113-2, . . . subject to causing a pseudofault. In this case, the second AND circuits A2-2, A2-4, . . . of the respective clip circuits 113-1, 113-2, . . . subject to causing a pseudofault constantly output “0”. As a result, the OR circuits O1-1, O1-2, . . . of the clip circuits 113-1, 113-2, . . . subject to causing the pseudofault output the output of the first AND circuits A2-1, A2-3, . . . .

In the mean time, “0” is input to the other input terminals of the first AND circuits A2-1, A2-3, . . . of the clip circuits 113-1, 113-2, . . . subject to causing the pseudofault during the clip period where “1” is output from the timer control circuit 112b-1 in a manner similar to the above-described case. On the other hand, “1” is input to the other input terminals of the first AND circuits A2-1, A2-3, . . . of the clip circuits 113-1, 113-2, . . . during the non-clip period where “0” is output from the timer control circuit 112b-1. Accordingly, the first AND circuits A2-1, A2-3, . . . of the clip circuits 113-1, 113-2, . . . subject to causing the pseudofault output the output data of the information processor 112a during the non-clip period, and output “0” during the clip period.

As a result, the OR circuits O1-1, O1-2, . . . of the clip circuits 113-1, 113-2, . . . subject to causing the pseudofault output “0” during the clip period where the timer control circuit 112b-1 outputs “1”. On the other hand, the OR circuits O1-1, O1-2, . . . of the clip circuits 113-1, 113-2, . . . output the output data of the information processor 112a during the non-clip period where the timer control circuit 112b-1 outputs “0”.

Accordingly, when the data are configured to be clipped at “0” as the pseudofault (i.e., CL=“0”), those subject to causing the pseudofault among the clip circuits 113-1, 113-2, . . . may output the following data. That is, the OR circuits O1-1, O1-2, . . . of the clip circuits output “0” during the clip period whereas the OR circuits O1-1, O1-2, . . . of the clip circuits output the output data of the information processor 112a during the non-clip period. Hence, in this case, the corresponding signal is clipped at “0” only during the clip period, the output data of the information processor 112a in a normal system operation are output during a period other than the clip period.

As described above, according to the pseudofault causing method according to the first embodiment, it may be possible to clip the optionally settable signal subject to causing the pseudofault at “0” or “1” in a fixed manner or an intermittent manner. As a result, the RAS function may be effectively verified (tested) by allowing the EG generating circuit 112b to cause a pseudofault while a system of the information processing apparatus 1000 is operating.

Hence, according to the first embodiment, the operations at the time of having a pseudofault caused in a specific signal may be simulated by implementing the pseudofault causing method in a logic circuit serving as hardware without specifically employing a tester device such as the BBC tester 500.

As a result, in terms of the above points a) and b), since the pseudofault is caused by the EG generating circuit 112b disposed inside the sender unit 110 mounted on the testing target printed circuit board 1100 subject to testing, the printed circuit board will not have limitations to its configuration. Accordingly, the pseudofault may be caused with respect to a desired signal so as to resolve the above points a) and b).

Further, in terms of the above points c) and d), the pseudofault that is clipped at “0” or the pseudofault that is clipped at “1” may be caused optionally. As a result, the pseudofault that fixes a negative logical signal indicating a 0 V representing an activating (assert) status to a deactivating (negate) status may be caused. Further, in a case of the pseudofault test being conduced at a system power-on state, even if a desired signal is simply in a state before it starts operating in the receiver unit, the pseudofault may be reliably caused by clipping the desired signal at “1” before it starts operating in the sender unit. Accordingly, the above points c) and d) are resolved.

Further, in term of the above point e), in a case of the pseudofault of the component having an error monitoring condition, the pseudofault matching a corresponding error monitoring condition may be caused. Accordingly, the above point e) is resolved.

### Second Embodiment

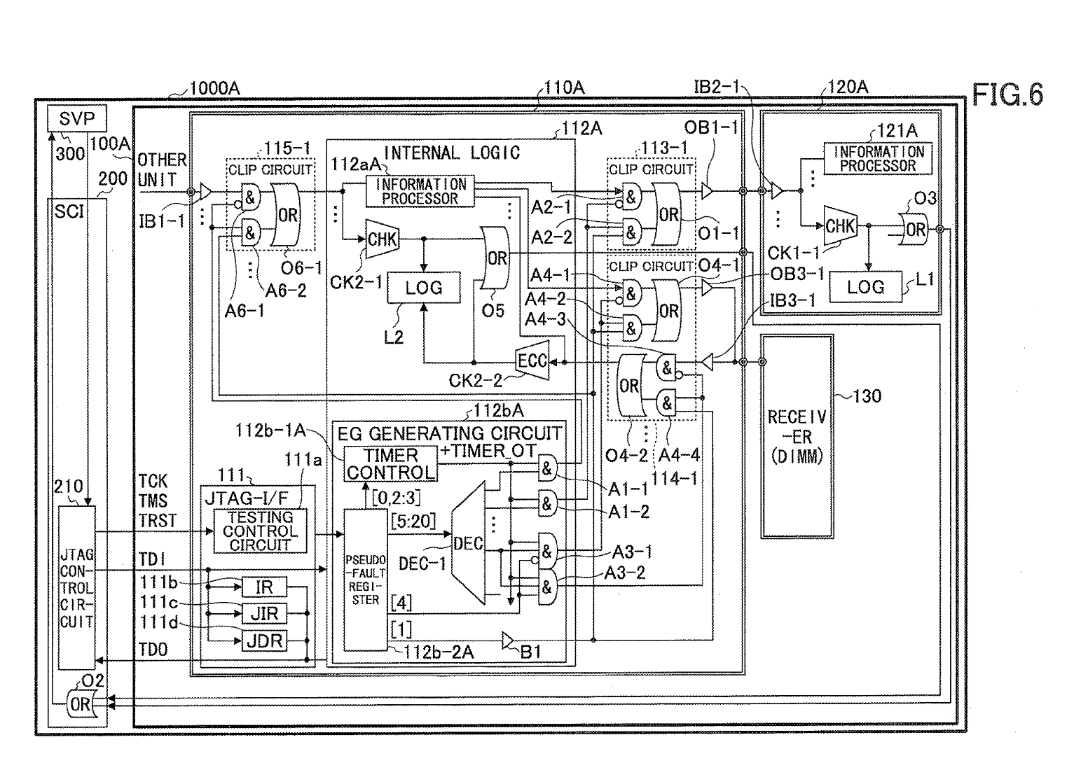

Next, a description is given of a second embodiment with reference to FIGS. 6 to 9.

An information processing apparatus 1000A illustrated in FIG. 6 includes a configuration similar to that of the information processing apparatus 1000 illustrated with reference to FIG. 4. Hence, in FIG. 6, those parts that are the same as those corresponding parts in FIG. 4 are designated by the same reference numerals, and a duplicated description thereof will appropriately be omitted.

The testing target printed circuit board 100A of the information processing apparatus 1000A illustrated in FIG. 6 includes a sender unit 110A, a receiver unit 120A, and a receiver unit 130. The receiver unit 130 may, for example, be a dual inline memory module (DMM) connected to the sender unit 110A via a wiring line performing bidirectional data communications such as a bidirectional bus.

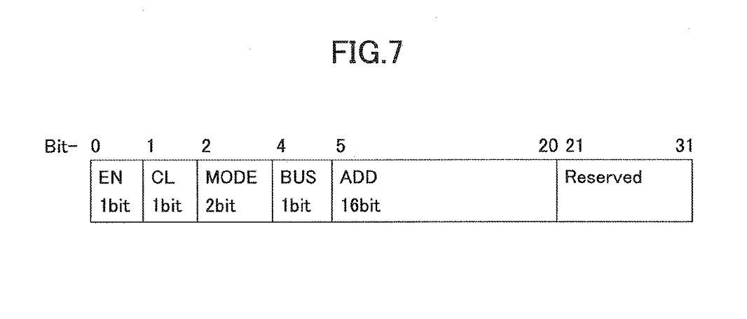

A pseudofault register 112b-2A of the EG generating circuit in an internal logic 112A of the sender unit 110A may, for example, include a configuration illustrated in FIG. 7. In this case, Bit(0) represents an enable bit (EN), Bit(1) represents a clip bit (CL) indicating a clip value, and 2 bits of Bit(2:3) represent a fault mode bit (MODE) indicating a fault mode in a manner similar to that illustrated in FIG. 5. Note that in the configuration of the second embodiment illustrated in FIG. 7, Bit(4) represents a bus bit (BUS) for selecting one of a signal (BUS) in a direction toward the sender unit and a signal (BUS) in a direction toward the receiver unit corresponding to a bidirectional data signal line so as to clip the selected one of the signals. Sixteen bits of Bit(5:20) represent an address bit (ADD) indicating an address designating a terminal (the maximum of 65536 pins) inputting or outputting a signal causing a pseudofault.

When the signal line of the receiver (input) unit corresponding to the bidirectional data signal line is clipped, “1” is set to the BUS bit, whereas when the signal line of the sender (output) unit corresponding to the bidirectional data signal line is clipped, “0” is set to the BUS bit. The corresponding signal of the BUS bit is connected to the later-described AND circuits A3-1, A3-2, . . . associated with the input/output terminals corresponding to the receiver unit 130. At this moment, the corresponding signal of the BUS bit is connected to the AND circuit A3-1 via an inverter circuit (represented by a circle in FIG. 6), whereas the corresponding signal of the BUS bit is directly connected to the AND circuit A3-2.

In the case of the second embodiment, the EG generating circuit 112bA includes the following AND circuits. That is, the EG generating circuit 112bA includes an AND circuit A1-1 associated with the input terminal corresponding to the not-illustrated sender unit, an AND circuit A1-2 associated with the output terminal corresponding to the receiver unit 120A, and the AND circuits A3-1 and A3-2 corresponding to the input/output terminals of the receiver unit 130. Note that FIG. 6 illustrates only one input terminal corresponding to the not-illustrated sender unit, one output terminal corresponding to the receiver unit 120A, one input terminal and one output terminal corresponding to the receiver unit 130; however, plural input/output terminals may be disposed corresponding to each one of the sender unit and the receiver units. When plural input terminals are disposed corresponding to the not-illustrated sender unit, the number of AND circuits corresponding to the number of the plural input terminals may be disposed. Likewise, when plural output terminals are disposed corresponding to the receiver unit 120A, the number of AND circuits corresponding to the number of the plural output terminals may be disposed. Further, when plural input/output terminals are disposed corresponding to the receiver unit 130, the number of AND circuits corresponding to twice the number of the plural input and output terminals may be disposed. This is because the AND circuits may need to be disposed in each of the sending and receiving directions.

The decode circuit DEC-1 is configured to output “1” to each of the AND circuits associated with the input terminals, the output terminals and the input/output terminals subject to causing a pseudofault, according to the settings of ADD fields of the pseudofault register 112b-2A, and output “0” to each of the AND circuits associated with the input terminals, the output terminals, and the input/output terminals other than those subject to causing the pseudofault. The timer control circuit 112b-1A is configured to output “1” during a data clip period when the EN bit is “1” according to the settings of the EN bit and the MODE field of the pseudofault register 112b-2A. As a result, those subject to causing the pseudofault among the AND circuits A1-1, A1-2, . . . to which “1” is input from the decoder circuit DEC-1 output “1” while the timer control circuit 112b-1A outputs “1”. On the other hand, those subject to causing the pseudofault among the AND circuits A1-1, A1-2, . . . to which “0” is input from the decoder circuit DEC-1 constantly output “0”.

Further, when “1” is input to each of the AND circuits A3-1, A3-2, . . . from the decoder circuit DEC-1, the AND circuits A3-1, A3-2, . . . perform the following operations. That is, when the BUS bit of the pseudofault register 112b-2A is “1” for selecting an input direction signal, the AND circuit A3-2 outputs “1” while “1” is input from the timer control circuit 112b-1A, whereas the AND circuit A3-2 outputs “0” while “0” is input from the decoder circuit DEC-1. On the other hand, the AND circuit A3-1 associated with the output signal constantly outputs “0”. By contrast, when the BUS bit of the pseudofault register 112b-2A is “0” for selecting an output direction signal, the AND circuit A3-1 outputs “1” while “1” is output from the timer control circuit 112b-1A, whereas the AND circuit A3-1 outputs “0” while “0” is input from the decoder circuit DEC-1. On the other hand, the AND circuit A3-2 associated with the input signal constantly outputs “0”.

The sender unit 110A includes clip circuits 113-1, 114-1, and 115-1 corresponding to input signals of the information processor 112aA. The clip circuits 113-1, 114-1, and 115-1 correspond to the output terminal of the receiver unit 120A, the input terminal of the not-illustrated sender unit, and the input/output terminals of the receiver unit 130. Accordingly, the number of clip circuits may be disposed corresponding to the number of the output terminals outputting output signals of the information processor 112aA corresponding to the receiver unit 120A. Likewise, the number of clip circuits may be disposed corresponding to the number of the input terminals inputting input signals of the information processor 112aA corresponding to the not-illustrated sender unit. Further, the number of clip circuits may be disposed corresponding to the number of the input/output terminals inputting or outputting output signals of the information processor 112aA corresponding to the receiver unit 130.

Further, the output terminal of the clip circuit 113-1, the output terminal and the input terminal of the clip circuit 114-1, and the input terminal of the clip circuit 115-1 are connected to the output terminal, and the input/output terminal of the sender unit 110A, and the internal logic 112A via the buffers OB1-1, OB3-1, IB3-1, and IB1-1, respectively. The output terminal, the input/output terminal, and the input terminal of the sender unit 110A are connected to counterpart input terminals of the receiver unit 120A via the wiring on the printed circuit board 100A.

The above input terminal of the receiver unit 120A is connected to the information processor 112A via a buffer IB2-1 and also connected to the error check circuit CK1-1. The error check circuit CK1-1 performs the error check operation in step S3 illustrated in FIG. 2. When an error is detected (“YES” in step S4 in FIG. 2) as a result of the error check operation, the content of the error log is reported to the SCI 200 via an OR circuit O3 while the content of the detected error is stored as an error log in the storage device L1 (step S5 in FIG. 2). The SCI 200 sends the report to the SVP 300 via an OR circuit O2. The receiver unit 130 includes a configuration similar to that of the receiver unit 120A after the above input/output terminal. Hence, the receiver unit 130 performs a data error check on the signal input from the input/output terminal, and stores, when the error is detected, the content of the error as a error log and reports the detected error to the SCI 200.

Further, in the sender unit 110A, the output terminal of the clip circuit 115-1 is connected to the information processor 112aA and also connected to the error check circuit CK2-1. The error check circuit CK2-1 performs the error check operation in step S3 illustrated in FIG. 2. When an error is detected (“YES” in step S4 in FIG. 2) as a result of the error check operation, the content of the error log is reported to the SCI 200 via the OR circuit O5 while the content of the detected error is stored as an error log in the storage device L2 (step S5 in FIG. 2). The SCI 200 sends the report to the SVP 300 via an OR circuit O2. Similarly, the output terminal of an OR circuit O4-2 of the clip circuit 114-1 is connected to the information processor 112aA and also connected to an error check and correct (ECC) circuit CK2-2. The ECC circuit CK2-2 is configured to detect a 1 bit or a 2 bit error, and correct the detected 1 bit error. When an error is detected by the ECC circuit CK2-2, the content of the error is reported to the SCI 200 via the OR circuit O5 while the content of the detected error is stored as an error log in the storage device L2 (step S5 in FIG. 2).

The clip circuits 113-1 and 115-1 include two AND circuits A2-1 and A2-2, and two AND circuits A6-1 and A6-2, respectively, and one OR circuit O1-1 and one OR circuit O6-1, respectively. In each of the clip circuits 113-1 and 115-1, the output terminals of two AND circuits are connected to the input terminal of the OR circuit. One of the input terminals of the AND circuit A2-1 of the clip circuit 113-1 is connected to a counterpart one of output terminals of the information processor 112aA. One of the input terminals of the AND circuit A6-1 of the clip circuit 115-1 is connected to one of output terminals of not-illustrated another unit via a buffer B1-1.

The output terminals of the first AND circuits A1-1 and A1-2 of the EG generating circuit 112bA are connected to the other input terminals of the AND circuits A6-1 and A2-1 of the counterpart clip circuits 115-1 and 113-1, respectively, via inverter circuits (each represented by a circle). Further, the output terminals of the AND circuits A1-1 and A1-2 of the EG generating circuit 112bA are further connected to the respective input terminals of the second AND circuits A6-2 and A2-2 of the counterpart clip circuits 115-1 and 113-1. Further, the pseudofault register 112b-2A indicating a value of a CL bit is connected to the other input terminals of the second AND circuits A6-2 and A2-2 of the clip circuits 115-1 and 113-1 via the buffer B1.

As a result, those subject to causing the pseudofault to which “1” is input from the decoder circuit DEC-1 of the clip circuits 115-1 and 113-1 may perform the following operations. That is, when the value of the CL bit of the pseudofault register 112b-2A is “1”, “1” is input to the other input terminals of the second AND circuits. Hence, the second AND circuits output “1” during a clip period where “1” is output from the timer control circuit 112b-1A. On the other hand, the second AND circuits output “0” during a non-clip period where “0” is output from the timer control circuit 112b-1A. As a result, the OR circuits O6-1 and O1-1 of the clip circuits 115-1 and 113-1 output “1” during the clip period where “1” is output from the timer control circuit 112b-1A. On the other hand, each of the OR circuits O6-1 and O1-1 of the clip circuits 115-1 and 113-1 output outputs of the first AND circuits of the clip circuits 115-1 and 113-1 during the non-clip period where “0” is output from the timer control circuit 112b-1A.

On the other hand, “0” is input to the other input terminals of the first AND circuits of the clip circuits 115-1 and 113-1 during the clip period where “1” is output from the timer control circuit 112b-1A. On the other hand, “1” is input to the other input terminals of the first AND circuits of the clip circuits 115-1 and 113-1 during the non-clip period where “0” is output from the timer control circuit 112b-1A. Accordingly, the first AND circuits of the clip circuits 115-1 and 113-1 output the output data of the information processor 112aA or the output data of the not-illustrated other unit during the non-clip period, and output “0” during the clip period.

As a result, the OR circuits O6-1 and O1-1 of the clip circuits 115-1 and 113-1 output “1” during the clip period where “1” is output from the timer control circuit 112b-1A. On the other hand, the OR circuits O6-1 and O1-1 of the clip circuits 115-1 and 113-1 output the output data of the information processor 112aA and the output data of the not-illustrated other unit during the non-clip period where “0” is output from the timer control circuit 112b-1A.

Accordingly, when the data are configured to be clipped at “1” as the pseudofault (i.e., CL=“1”), those subject to causing the pseudofault to which “1” is input from the decoder circuit DEC-1 of the clip circuits 113-1 and 115-1 may output the following data. That is, “1” is output during the clip period whereas the output data of the information processor 112aA or the output data of the not-illustrated other unit are output during the non-clip period. Hence, in this case, the corresponding signal is clipped at “1” only during the clip period, the output data of the information processor 112aA or the output data of the not-illustrated other unit in a normal system operation are output during a period other than the clip period.

Next, a description is given of a case where “0” is set to the CL bit as the setting of the data being clipped at “0” (i.e., CL=“0”) as a pseudofault. In this case, “0” is input to the other input terminals of the second AND circuits of the respective clip circuits subject to causing a pseudofault. Hence, the second AND circuits constantly output “0”. As a result, the OR circuits output the outputs of the first AND circuits.

On the other hand, “0” is input to the other input terminals of the first AND circuits during the clip period where “1” is output from the timer control circuit 112b-1A. On the other hand, “1” is input to the other input terminals of the first AND circuits during the non-clip period where “0” is output from the timer control circuit 112b-1A. Accordingly, the first AND circuits output the output data of the information processor 112aA or the output data of the not-illustrated other unit during the non-clip period, and output “0” during the clip period.

As a result, the OR circuits of the clip circuits subject to causing the pseudofault output “0” during the clip period where “1” is output from the timer control circuit 112b-1A. On the other hand, the OR circuits of the clip circuits subject to causing the pseudofault output the output data of the information processor 112aA or the output data of the not-illustrated other unit during the non-clip period where “0” is output from the timer control circuit 112b-1A.

Accordingly, when the data are configured to be clipped at “0” as the pseudofault (i.e., CL=“0”), those subject to causing the pseudofault to which “1” is input from the decoder circuit DEC-1 of the clip circuits 113-1 and 115-1 may output the following data. That is, “0” is output during the clip period whereas the output data of the information processor 112aA or the output data of the not-illustrated other unit are output during the non-clip period. Hence, in this case, the corresponding signal is clipped at “0” only during the clip period, the output data of the information processor 112aA or the output data of the not-illustrated other unit in a normal system operation are output during a period other than the clip period.

The clip circuit 114-1 includes two combinations of AND circuits A4-1 and A4-2, and A4-3 and A4-4, and two OR circuits O4-1 and O4-2. The respective output terminals of the AND circuits A4-1 and A4-2 are connected to the input terminals of the OR circuit O4-1. Similarly, the respective output terminals of the AND circuits A4-3 and A4-3 are connected to the input terminals of the OR circuit O4-2. Further, one of the input terminals of the AND circuits A4-1 of the clip circuit 114-1 is connected to a counterpart one of the output terminals of the information processor 112aA. In addition, one of the input terminals of the AND circuit A4-3 of the clip circuit 114-1 is connected to an output terminal of the receiver unit 130 via the buffer B3-1.

The output terminals of the AND circuits A3-1 and A3-2 of the EG generating circuit 112bA are connected to the other input terminals of the AND circuits A4-1 and A4-3 of the counterpart clip circuits 114-1 via inverter circuits (each represented by a circle). Further, the output terminals of the AND circuits A3-1 and A3-2 of the EG generating circuit 112bA are further connected to the respective input terminals of the AND circuits A4-2 and A4-4 of the counterpart clip circuit 114-1. Further, the pseudofault register 112b-2A indicating a value of a CL bit is connected to the other input terminals of the AND circuits A4-2 and A4-4 of the clip circuit 114-1 via a buffer B1.

As a result, when the clip circuit 114-1 is the one subject to causing the pseudofault to which “1” is input from the decoder circuit DEC-1, the following operations may be performed. That is, when the value CL of the pseudofault register 112b-2A is “1”, “1” is input to the other input terminals of the AND circuits A4-2 and A4-4. As a result, when an input signal is selected (BUS=“1”), the AND circuit A4-4 associated with the input signal outputs “1” during the clip period where “1” is output from the timer control circuit 112b-1A, whereas the AND circuit A4-4 outputs “0” while “0” is input from the timer control circuit 112b-1A. On the other hand, the AND circuit A4-3 associated with the input signal outputs “0” by inverting the selected input signal during the clip period where “1” is output from the timer control circuit 112b-1A, whereas the AND circuit A4-3 outputs the output data of the receiver unit 130 as they are during the non-clip period where “0” is output from the timer control circuit 112b-1A. Further, in this case, since the AND circuit A4-2 associated with the output signal constantly outputs “0”, the OR circuit O4-1 associated with the output signal outputs an output of the AND circuit A4-1, whereas “1” is input to the other input terminal of the AND circuit 4-1 by inverting “0”. Hence, the OR circuit O4-1 outputs the output data of the information processor 112aA as they are.

Likewise, when an output signal is selected (BUS=“0”), the AND circuit A4-2 associated with the output signal outputs “1” during the clip period where “1” is output from the timer control circuit 112b-1A, whereas the AND circuit A4-2 outputs “0” during the non-clip period where “0” is input from the timer control circuit 112b-1A. On the other hand, the AND circuit A4-1 associated with the output signal outputs “0” by inverting “1” during the clip period where “1” is output from the timer control circuit 112b-1A, whereas the AND circuit A4-1 outputs the output data of the information processor 112aA as they are during the non-clip period where “0” is output from the timer control circuit 112b-1A. Further, in this case, since the AND circuit A4-4 associated with the input signal outputs “0”, the OR circuit O4-2 associated with the input signal outputs an output of the AND circuit A4-3, whereas “1” is input to the other input terminal of the AND circuit 4-3 by inverting “0”. Hence, the AND circuit A4-3 outputs the output data of the receiver unit 130 as they are.

As a result, when the clip circuit 114-1 is selected by being supplied with “1” from the decoder circuit DEC-1 as the clip circuit subject to causing the pseudofault, the OR circuit associated with the selection of the input signal and the output signal of the OR circuits O4-1 and O4-2 outputs “1” during the clip period where “1” is output from the timer control circuit 112b-1A, whereas the OR circuit outputs the output data of the information processor 112aA or the output data of the receiver unit 130 during the non-clip period where “0” is output from the timer control circuit 112b-1A. On the other hand, the OR circuit associated with the non-selection of the input signal and the output signal of the OR circuits O4-1 and O4-2 of the clip circuit 114-1 outputs the output data of the information processor 112aA or the output data of the receiver unit 130.

Accordingly, when the clip circuit 114-1 is the one subject to causing the pseudofault to which “1” is input from the decoder circuit DEC-1 and having the setting of the data being clipped at “1” as a pseudofault (CL=“1”), the following operations may be performed. That is, the OR circuit associated with the selection of the input signal and the output signal of the OR circuits O4-1 and O4-2 of the clip circuit 114-1 outputs “1” during the clip period. Further, the OR circuit associated with the selection of the input signal and the output signal outputs the output data of the information processor 112aA or the output data of the receiver unit 130 during the non-clip period. Hence, in this case, the corresponding signal is clipped at “1” only during the clip period, the output data of the information processor 112aA or the output data of the receiver unit 130 in a normal system operation are output during a period other than the clip period. On the other hand, the OR circuit associated with the non-selection of the input signal and the output signal of the OR circuits O4-1 and O4-2 of the clip circuit 114-1 outputs the output data of the information processor 112aA or the output data of the receiver unit 130. That is, the signal in the normal system operation is output.

Next, a description is given of a case where the data are clipped at “0” (i.e., CL=“0”) as a pseudofault. In this case, “0” is input to the other input terminals of the AND circuits A4-2 and A4-4 of the clip circuit 114-1. Hence, the AND circuit associated with the selection of the input signal and the output signal of the AND circuits A4-2 and A4-4 constantly outputs “0”. As a result, one of the OR circuits O4-1 and O4-2 associated with the selection of the input signal and the output signal outputs a corresponding one of the outputs of the AND circuits A4-1 and A4-3.

Note that “0” is input to the other input terminal of the AND circuit associated with the selection of the input signal and the output signal of the AND circuits A44-1 and A4-3 by inverting “1” during the clip period where “1” is output from the timer control circuit 112b-1A, whereas “1” is input to the other input terminal of the AND circuit associated with the selection of the input signal and the output signal by inverting “0” during the non-clip period where “0” is output from the timer control circuit 112b-1A. Accordingly, the AND circuit associated with the selection of the input signal and the output signal of the AND circuits A4-1 and A4-3 outputs the output data of the information processor 112aA or the output data of the receiver unit 130 during the non-clip period. On the other hand, the AND circuit associated with the selection of the input signal and the output signal outputs “0” during the clip period. Further, “1” is input to the other input terminal of the AND circuit associated with the non-selection of the input signal and the output signal of the AND circuits A4-1 and A4-3 by inverting “0”. Accordingly, the AND circuit associated with the non-selection of the input signal and the output signal outputs the output data of the information processor 112aA or the output data of the receiver unit 130.

As a result, when the clip circuit 114-1 is the one subject to causing the pseudofault, the OR circuit associated with the selection of the input signal and the output signal outputs “0” during the clip period where “1” is output from the timer control circuit 112b-1A, whereas the OR circuit associated with the selection of the input signal and the output signal outputs the output data of the information processor 112aA or the output data of the receiver unit 130 during the non-clip period where “0” is output from the timer control circuit 112b-1A. On the other hand, the OR circuit associated with the non-selection of the input signal and the output signal outputs the output data of the information processor 112aA or the output data of the receiver unit 130.

Accordingly, when the data are configured to be clipped at “0” as the pseudofault (i.e., CL=“0”), and the clip circuit 114-1 is the one subject to causing the pseudofault, the following data may be output. That is, “0” is output from the OR circuit associated with the selection of the input signal and the output signal during the clip period whereas the output data of the information processor 112aA or the output data of the receiver unit 130 are output during the non-clip period. Hence, in this case, the corresponding signal is clipped at “0” only during the clip period, the output data of the information processor 112aA or the output data of the receiver unit 130 in a normal system operation are output during a period other than the clip period. On the other hand, the OR circuit associated with the non-selection of the input signal and the output signal outputs the output data of the information processor 112aA or the output data of the receiver unit 130. Accordingly, the signal in the normal system operation is output in this case.

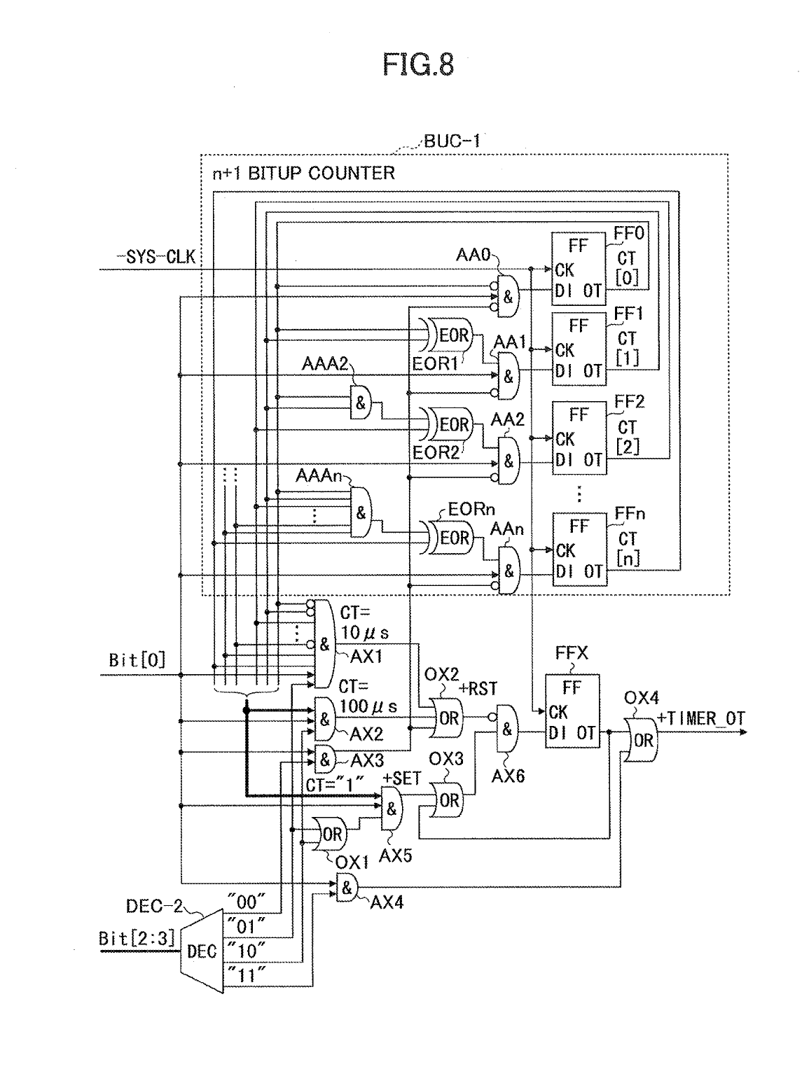

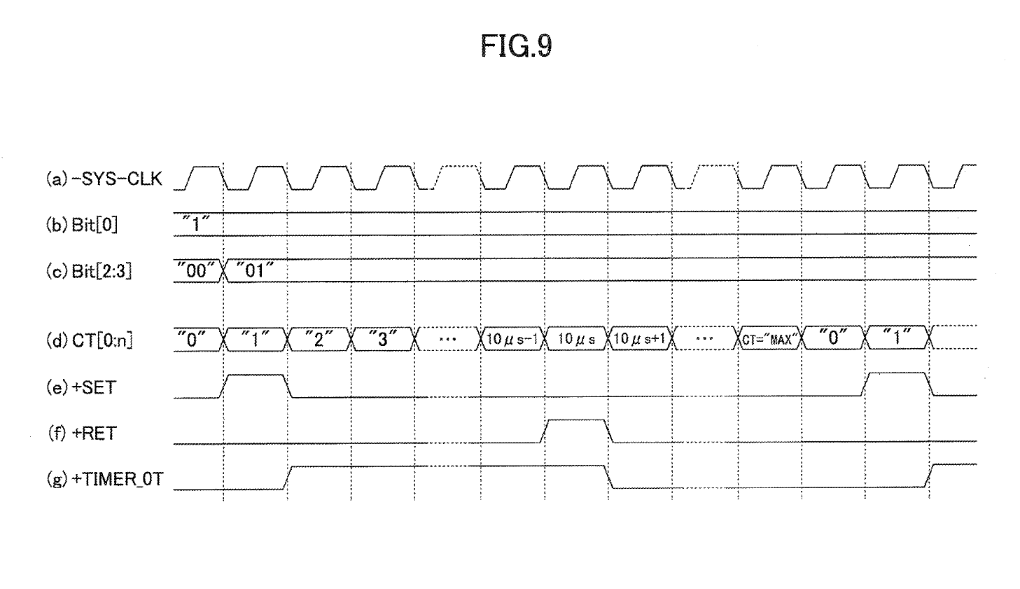

FIG. 8 illustrates a circuit configuration example of the timer control circuit 112b-1A illustrated in FIG. 6. FIG. 9 is a timing chart illustrating an example of an operational flow of the timer control circuit 112b-1A.

The timer control circuit 112b-1A illustrated in FIG. 8 includes an (n+1) bit up counter BUC-1 configured to count up a counted value CT by +1 from 0 when the EN bit of the Bit(0) of the pseudofault register 112b-2A is effective (EN=“1”).

The (n+1) bit up counter BUC-1 includes n+1 flip-flops FF0, FF1, to FFn, and AND circuits AA0, AA1, to AAn connected to respective data input terminals D1 of the n+1 flip-flops FF0, FF1, to FFn.

Respective output terminals OT of the flip-flops FF0 to FFn are connected to the first input terminals of the AND circuits AA0 to AAn via inverter circuits (each represented by a circle in FIG. 8), and the later-described EOR1 to EORn are connected to the AND circuits AA1 to AAn. EN bit output terminals of the pseudofault register 112b-2A are connected to the second input terminals of the AND circuits AA0 to AAn. Further, an output terminal of the later-described AND circuit AX3 is connected to the third input terminals of the AND circuits AA0 to AAn via inverter circuits (each represented by a circle in FIG. 8).

The (n+1) bit up counter BUC-1 further includes exclusive OR circuits EOR1 to EORn connected to the respective first input terminals of the AND circuits AA0 to AAn. The respective output terminals of the flip-flops FF0 and FF1 are connected to two input terminals of the exclusive OR circuit EOR1. The later-described AND circuits AAA2 to AAAn are connected to the first input terminals of the exclusive OR circuits EOR2 to EORn. Further, the output terminals OT of the flip-flops FF2 to FFn connected via the AND circuits AAA2 to AAAn are connected to the second input terminals of the exclusive OR circuits EOR2 to EORn.

The (n+1) bit up counter BUC-1 further includes the AND circuits AAA2 to AAAn connected to the second terminals of the exclusive OR circuits EOR2 to EORn other than that of the EOR1. The following terminals may be connected to the respective input terminals of the AND circuits AAA2 to AAAn. In FIG. 8, all the output terminals OT of the flip-flops other than those illustrated above the FFn are connected to the AND circuits AAA2 to AAAn via the EOR2 to EORn, or via the EORn and the AND circuit AAA2 to AAAn.

The (n+1) bit up counter BUC-1 counts a counted value up by +1 at a timing of a system clock signal −SYS-CLK input into respective clock input terminals CK of the flip-flops FF0, FF1, to FFn. The counted value CT (n bits) of the (n+1) bit up counter BUC-1 may be obtained by the respective output terminals OT of the flip-flops FF0, FF1, to FFn. Further, when the MODE field of the Bit(2:3) of the pseudofault register 112b-2A indicates “00” (i.e., reset), the respective outputs of the AND circuits AAA0, AAA1, to AAAn are fixed to “0”. As a result, the counted value CT of the (n+1) bit up counter BUC-1 is constantly fixed to “0” so as to allow the (n+1) bit up counter BUC-1 to stop the counted operation.

The timer control circuit 112b-1A illustrated in FIG. 8 further includes AND circuits AX1, AX2, AX3, AX4, AX5 and AX6, OR circuits OX1, OX2, OX3 and OX4, and a flip-flop FFX. The timer control circuit 112b-1A illustrated in FIG. 8 further includes a decoder DEC-2 configured to decode the MODE field serving as the fault mode of the Bit(2:3) of the pseudofault register 112b-2A.

Further, output terminals of the (n+1) bit up counter BUC-1 are connected to the input terminals of the AND circuit AX1 either directly or via inverter circuits (each represented by a circle in FIG. 8). In this embodiment, the inverter circuits are inserted such that the AND circuit AX1 is capable of outputting “1” when all the input values are “1” with the counted value CT matching the time at which 10 μs has elapsed since the (n+1) bit up counter BUC-1 starts incrementing by +1 from “0”. EN bit output terminals of the pseudofault register 112b-2A are connected to the other input terminals of the AND circuit AX1. One of the output terminals of the decoder circuit DEC-2 that outputs “1” as a decoding result when the MODE field of the pseudofault register 112b-2A indicates “01” (i.e., a 10 μs intermittent setting) is connected to a further another input terminal of the AND circuit AX1. As a result, even when EN=“1” and the fault MODE is “01” (i.e., a 10 μs intermittent setting), the AND circuit AX1 outputs “1” every time 10 μs has elapsed. On the other hand, the AND circuit AX1 outputs “0” excluding the above times at which 10 μs has elapsed.

Similarly, output terminals of the (n+1) bit up counter BUC-1 are connected to the input terminals of the AND circuit AX2 either directly or via inverter circuits (each represented by a circle in FIG. 8). In this embodiment, the inverter circuits are inserted such that the AND circuit AX2 is capable of outputting “1” when all the input values are “1” with the counted value CT matching the time at which 100 μs has elapsed since the (n+1) bit up counter BUC-1 starts incrementing by +1 from “0”. EN bit output terminals of the pseudofault register 112b-2A are connected to the other input terminals of the AND circuit AX2. One of the output terminals of the decoder circuit DEC-2 that outputs “1” when the MODE field (the fault mode) of the pseudofault register 112b-2A indicates “10” (i.e., a 100 μs intermittent setting) is connected to a further another input terminal of the AND circuit AX2. As a result, even when EN=“1” and the MODE field indicates “10” (i.e., a 100 μs intermittent setting), the AND circuit AX2 outputs “2” every time 100 μs has elapsed. On the other hand, the AND circuit AX2 outputs “0” excluding the above times at which 100 μs has elapsed.

One of the EN bit output terminals of the pseudofault register 112b-2A and the output terminals of the decoder circuit DEC-2 that outputs “1” when the MODE field of the pseudofault register 112b-2A indicates “00” (i.e., resetting) is connected to the input terminals of the AND circuit AX3. As a result, even when EN=“1” and the fault MODE is “00” (i.e., resetting), the AND circuit AX3 outputs “1”.

Respective output terminals of the AND circuits AX1, AX2, and AX3 are connected to the input terminals of the OR circuit OX2. As a result, when the MODE field has a 10 μs intermittent setting (MODE=“01”), the OR circuit OX2 outputs an output of the AND circuit AX1 as it is. That is, the OR circuit OX2 outputs “1” every time 10 μs has elapsed, and outputs “0” excluding the times at which 10 μs has elapsed. Similarly, when the MODE field has a 100 μs intermittent setting (MODE=“01”), the OR circuit OX2 outputs an output of the AND circuit AX1 as it is. That is, the OR circuit OX2 outputs “1” every time 100 μs has elapsed, and outputs “0” excluding the times at which 100 μs has elapsed (+RST). Further, when the MODE field indicates resetting (MODE=“00”), the OR circuit OX2 outputs an output of the AND circuit AX3 as it is. That is, the OR circuit OX2 outputs outputs “1”.

Output terminals of the pseudofault register 112b-2A, one of which outputs “1” when the MODE field serving as the Bit(2:3) of the pseudofault register 112b-2A indicates “01” (i.e., 10 μs intermittent setting), and the other of which outputs “1” when the MODE field serving as the Bit(2:3) of the pseudofault register 112b-2A indicates “10” (i.e., 100 μs intermittent setting), are connected to the input terminals of the OR circuit OX1, respectively. Further, output terminals of the (n+1) bit up counter BUC-1 are connected to the input terminals of the AND circuit AX5 either directly or via inverter circuits. In this embodiment, the inverter circuits are inserted in the input terminals of the AND circuit AX5 such that the AND circuit AX5 outputs “1” when all the input values are “1” in a state of the counted value CT=“1” of the (n+1) bit up counter BUC-1. EN bit output terminals of the pseudofault register 112b-2A are connected to the other input terminals of the AND circuit AX5, and the output terminal of the above OR circuit OX1 is connected to a further another input terminal of the AND circuit AX5. As a result, when EN=“1”, the MODE field has 10 μs or 100 μs intermittent setting, and the counted value of the (n+1) bit up counter BUC-1 is “1” (i.e., the counted value CT=“1”), the AND circuit AX5 outputs “1”.

Further, the output terminal OT of the flip-flops FFX and the output terminal of the AND circuit AX5 are connected to the input terminals of the OR circuit OX3, respectively, and the other input terminal of the AND circuit AX6 is connected to the output terminal of the OR circuit OX3. In addition, an output terminal (+RST) of the OR circuit OX2 is connected to the first input terminal of the AND circuit AX6 via an inverter circuit (represented by a circle in FIG. 8).

One of the EN bit output terminals of the pseudofault register 112b-2A and one of the output terminals of the decoder circuit DEC-2 that outputs “1” when the MODE field of the decoder circuit DEC-2 indicates “11” (i.e., normal setting) are connected to the respective input terminals of the AND circuit AX4. Accordingly, when EN=“1”, and the MODE field includes normal setting (MODE=“11”), the AND circuit AX4 outputs “1”. In this case, the OR circuit OX4 outputs “1”. Accordingly, in this case (i.e., the normal setting), the timer control circuit 112b-1A outputs “1” in a fixed manner (+TIMER_OT). On the other hand, when the MODE field includes setting (i.e., MODE=“00”, “01”, or “10”) other than the normal setting (“11”), the OR circuit OX4 outputs an output value of the flip-flop FFX.

Hence, when EN=“1”, and the MODE field includes the resetting (MODE=“00”), the AND circuit AX3 outputs “1”, which is inverted into “0” by the inverter circuit via the OR circuit OX2. The inverted output “0” is then input to one of the input terminals of the AND circuit AX6. As a result, the AND circuit AX6 outputs “0”. Subsequently, the flip-flop FFX acquires the “0” output from the AND circuit AX6, and then outputs “0” (OT). Thereafter, the “0” output from the flip-flop FFX is acquired by the OR circuit OX4, which outputs the acquired “0” as it is. That is, when EN=“1”, and the MODE field indicates the resetting (MODE=“00”), the timer control circuit 112b-1A outputs “0”. On the other hand, when EN=“0”, the (n+1) bit up counter BUC-1 does not perform a counting operation. Hence, the CT will not be “1”, and the AND circuit AX5 will not output “1”. Thus, “1” will not be input to a data input terminal D1 of the flip-flop FFX via the OT circuit OX3, and the AND circuit AX6. The flip-flop FFX outputs “0”, and timer control circuit 112b-1A outputs “0”.

Further, when the MODE field includes 10 μs (MODE=“10”) or 100 μs (MODE=“100”) intermittent setting, the AND circuit AX5 outputs “1” (+SET) at a timing of the CT=“1” immediately after the (n+1) bit up counter BUC-1 starts counting. The “1” output by the AND circuit AX5 is supplied via the OR circuit OX3 to other input terminal of the AND AX6. On the other hand, the AND circuit AX1 or AX2 outputs “0” before 10 μs or 100 μs has elapsed. The “0” output by the AND circuit AX1 or AX2 is supplied to the OR circuit OX2, and then inverted into “1” by the inverter circuit. The inverted output “1” is then input into one of the input terminals of the AND circuit AX6. As a result, the AND circuit AX6 outputs “1”. Subsequently, the flip-flop FFX acquires the “1” output from the AND circuit AX6, and then outputs “1”. The “1” output by the AND circuit AX6 is then input to the flip-flop FFX via the OR circuit OX3 and the AND circuit AX6. Accordingly, the flip-flop FFX outputs “1” and the timer control circuit 112b-1A outputs “1” before 10 μs or 100 μs has elapsed.

Next, the AND circuit AX1 or AX2 outputs “1” at the time at which 10 μs or 100 μs has elapsed based on the setting of the MODE field. The AND circuit AX1 or AX2 outputs “1”, which is supplied to the OR circuit OX2, and then inverted into “0” by the inverter circuit. The inverted output “0” is then input into one of the input terminals of the AND circuit AX6. The “0” input into the input terminal of the AND circuit AX6 is acquired by the flip-flop FFX, so that the flip-flop FFX outputs the received “0”. The “0” is input into the flip-flop FFX via the OR circuit OX3 and the AND circuit AX6. As a result, the flip-flop FFX outputs “0”, and timer control circuit 112b-1A outputs “0”, thereafter.

The (n+1) bit up counter BUC-1 further continues to perform counting operations. As a result, output values of all the flip-flops FF0, FF1, to FFn are the maximum value of “1”, which are switched to “0” at a subsequent timing. That is, the counted value is automatically reset to “0”, and the (n+1) bit up counter BUC-1 subsequently starts incrementing by +1 from the CT=“1” in a similar manner as the above.

Accordingly, when the MODE field includes 10 μs or 100 μs intermittent setting, and the counted value CT of the (n+1) bit up counter BUC-1 is “1” (i.e., the counted value CT=“1”), the timer control circuit 112b-1A outputs “1”. Thereafter, the timer control circuit 112b-1A outputs “1” until next 10 μs or 100 μs has elapsed. When the next 10 μs or 100 μs has elapsed, the timer control circuit 112b-1A outputs “0”. Further, when the (n+1) bit up counter BUC-1 continues to count up the counted value by +1 to result in the counted value CT to be the maximum value, the counted value CT is reset to “0”. When the counted value CT is “1” (CT=“1”) again, the timer control circuit 112b-1A outputs “1” again. Then, the timer control circuit 112b-1A outputs “1” until next 10 μs or 100 μs has elapsed again. Thereafter, the above-described operation is repeatedly carried out. That is, the following sequence of operations is repeatedly carried out: during the initial 10 μs or 100 μs, the timer control circuit 112b-1A outputs “1”, subsequently outputs “0” until the (n+1) bit up counter BUC-1 is reset, and outputs “1” again during the initial 10 μs or 100 μs after having the (n+1) bit up counter BUC-1 being reset. As a result, a pseudofault status in which a specific signal is clipped at “1” or “0” may be maintained during 10 μs or 100 μs. Thereafter, a pseudofault cancelled status is maintained for certain duration, and the pseudofault status is maintained during the next 10 μs or 100 μs again.

Next, a description is given of operations of the timer control circuit 112b-1A with reference to a timing chart illustrated in FIG. 9. In FIG. 9, (a) indicates a waveform of a system clock signal (−SYS-CLK), and (b) indicates an EN bit value of the pseudofault register 112b-2A. Further, (c) indicates a fault mode (MODE=“00”, “01”, “10”, or “11”), and d) indicates a counted value (CT) of the (n+1) bit up counter BUC-1. Next, (e) indicates an output value (+SET) of the AND circuit AX5, and (f) indicates an output value (+RST) of the OR circuit OX2. Finally, (g) indicates an output value (+TIME_OT) of the OR circuit OX4, that is, an output value of the timer control circuit 112b-1A.

In FIG. 9, the EN bit is set as “1”, and the fault MODE is reset (MODE=“00”). In the above condition, since the AND circuit AX3 outputs “1”, the (n+1) bit up counter BUC-1 will not perform the counting operation as described above.

Next, “01” (10 μs intermittent setting) is set to the Bit(2:3) (MODE field) in (c) illustrated in FIG. 9, for example. As a result, the (n+1) bit up counter BUC-1 starts counting ((d)) (CT=“1”), and the AND circuit AX5 ((e)) simultaneously outputs “1”. The “1” output by the AND circuit AX5 is supplied via the OR circuit OX3 to other input terminal of the AND AX6. Further, the AND circuit AX1 when the MODE field indicates “01” (10 μs intermittent setting) outputs “0” before 10 μs has elapsed, and the “0” transmitted via the OR circuit OX2 is inverted into “1” by an inverter circuit. The inverted “1” is then input into one of input terminals of the AND circuit AX6. As a result, the AND circuit AX6 outputs “1”, which is then acquired by the flip-flop FFX. The “1” acquired by the flip-flop FFX is input to the OR circuit OX4, and subsequently output from the OR circuit OX4 (+TIMER_OT)((g)). The “1” output from the OR circuit OX4 is input into the OR circuit OX3, and then input into the flip-flop FFX via the AND circuit AX6. As a result, “1” is maintained as the output +TIMER_OT of the OR circuit OX4, that is, the output of the timer control circuit 112b-1A until the counted value of the (n+1) bit up counter BUC-1 reaches a value corresponding to 10 μs.

When the counted value of the (n+1) bit up counter BUC-1 reaches a value corresponding to 10 μs, the AND circuit AX1 outputs “1”. The “1” output by the AND circuit AX1 is then transmitted to the OR circuit OX2 (+RST) ((f)), and subsequently transmitted to the inverter circuit. The “1” supplied to the inverter circuit is inverted into “0” and is then input into the AND circuit AX6. As a result, the AND circuit AX6 outputs “0”, which is then acquired by the flip-flop FFX. The flip-flop FFX then outputs “0”, which is input to the other input terminal of the OR circuit OX3. At this moment, since an input value of the counted value of the AND circuit AX5 is not CT=“1”, the value of one of the input terminals of the OR circuit OX3 is “0”. As a result, the OR circuit OX3 outputs “0”. As a result of the output of the OR circuit OX3, the value of the output terminal of the AND circuit AX6 is “0”. Hence, the flip-flop FFX acquires the “0” output from the AND circuit AX6, and then outputs “0” (OT). The “0” output by the flip-flop FFX is then output from the timer control circuit 112b-1A ((g)) via the OR circuit OX4. Thereafter, an input value of the counted value of the AND circuit AX5 is CT=“1” again. Hence, the timer control circuit 112b-1A will output “0” ((g)) until the AND circuit AX5 outputs “1”.

That is, the (n+1) bit up counter BUC-1 continues to count so that the CT acquires the maximum value ((d)) (CT=“1”), and the CT is subsequently cleared to acquire “0”. When the CT acquires CT=“1” again, the AND circuit AX5 outputs “1” (+SET) ((e)). Then, the “1” output by the AND circuit AX5 is transmitted via the OR circuit OX3 and the AND circuit AX6 to be acquired by the flip-flop FFX in a similar manner as described above. The flip-flop FFX then outputs “1”, which is output from the timer control circuit 112b-1A via the OR circuit OX4 ((g)). Thereafter, the operation similar to the above will be repeated according to the counting operation of the (n+1) bit up counter BUC-1. That is, when the (n+1) bit up counter BUC-1 starts counting, the timer control circuit 112b-1A outputs “1” until 10 μs has elapsed. After 10 μs has elapsed, the counted value CT of the (n+1) bit up counter BUC-1 acquires the maximum value. Then, the timer control circuit 112b-1A outputs “0” until the counted value CT of the (n+1) bit up counter BUC-1 is reset and starts counting from CT=“1” again. Thereafter, the counted value CT of the (n+1) bit up counter BUC-1 acquires the maximum value. When the counted value CT of the (n+1) bit up counter BUC-1 is reset and starts counting from CT=“1” again, the timer control circuit 112b-1A outputs “1” until 10 μs has elapsed, as described above. Thereafter, the following sequence of operations is repeatedly carried out: during an initial 10 μs, the timer control circuit 112b-1A outputs “1”, subsequently outputs “0” until the (n+1) bit up counter BUC-1 is reset, and outputs “1” again during the initial 10 μs after having the (n+1) bit up counter BUC-1 being reset.

### Third Embodiment

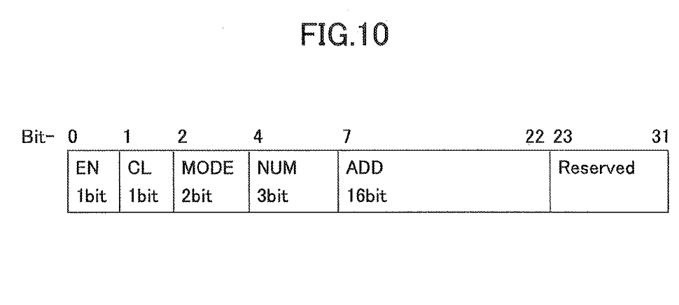

Next, a description is given of a third embodiment with reference to FIGS. 10 to 13. An information processing apparatus 1000B according to the third embodiment includes a configuration similar to that of the information processing apparatus 1000A according to the second embodiment with reference to FIGS. 6 to 9. Hence, in FIGS. 10 to 13, those parts that are the same as those corresponding parts in FIGS. 6 to 9 are designated by the same reference numerals, and a duplicated description thereof will appropriately be omitted.

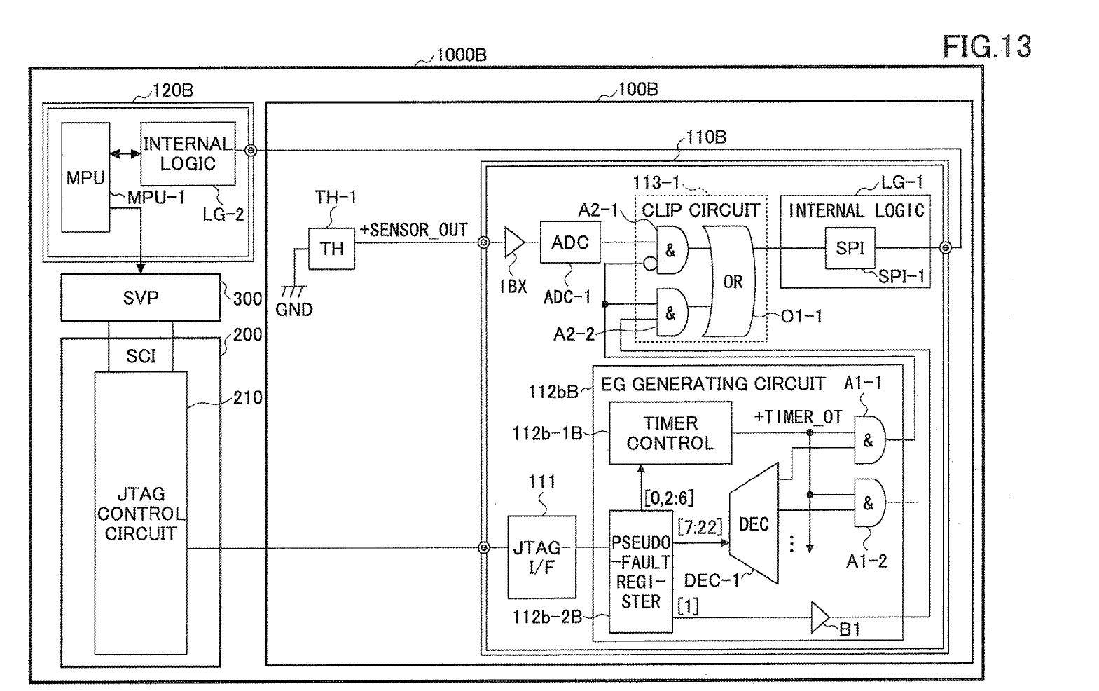

FIG. 10 illustrates a configuration example of a pseudofault register 112-2B (see FIG. 13) for use in a pseudofault causing method according to the third embodiment. In this embodiment, Bit(0) represents an enable bit (EN), Bit(1) represents a clip bit (CL) indicating a clip value, and 2 bits of Bit(2:3) represent a fault mode bit (MODE) indicating a fault mode in a manner similar to the second embodiment illustrated in FIG. 7. Note that in the third embodiment, the intermittent setting by the MODE field corresponds to 10 ms or 100 ms intermittent setting instead of the 10 μs or 100 μs intermittent setting. Further, 3 bits of Bit(4:6) represents NUM field designating the number of times the pseudofault is caused when only the designated number of times the pseudofault is caused in the signal subject to causing the pseudofault at the intermittent setting. Thus, a desired number of times (i.e., the designated times) may be specified (selected) from a range of bits of the NUM field (three bits) from once to seven times (i.e., NUM=“001” to “111”) as the number of times the pesudofault is caused. Sixteen bits of Bit(7:22) represent the ADD bits indicating an address designating a terminal (the maximum of 65536 pins) inputting or outputting a signal causing a pseudofault.

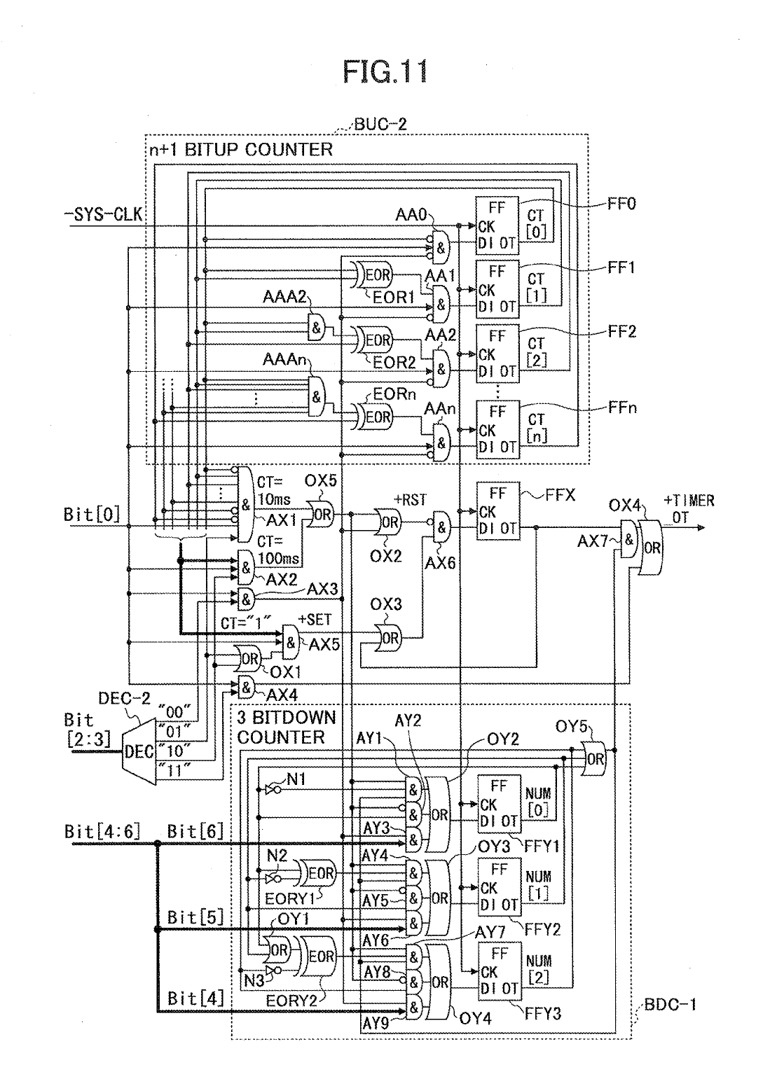

FIG. 11 illustrates a circuit configuration example of the pseudofault register 112b-2B (see FIG. 13) for use in the pseudofault causing method according to the third embodiment. The circuit configuration of the timer control circuit 112b-1B includes circuit configuration elements similar to those of the timer control circuit 112b-1A illustrated with reference to FIG. 8. Hence, in FIG. 13, those parts that are the same as those corresponding parts in FIG. 11 are designated by the same reference numerals, and a duplicated description thereof will appropriately be omitted.

Note that the timer control circuit 112b-1B illustrated in FIG. 11 differs from the timer control circuit 112b-1A illustrated in FIG. 8 in that the timer control circuit 112b-1B includes a 3-bit down counter BDC-1. The 3-bit down counter BDC-1 includes three flip-flops FFY1, FFY2, and FFY3, each of which indicates a bit value indicating a counted value to be output from a corresponding one of their OT terminals. The 3-bit down counter BDC-1 further includes an OR circuit OR5 an input terminal of which is connected to the output terminals of the flip-flops FFY1, FFY2, and FFY3. The 3-bit down counter BDC-1 further includes an AND circuit AX7. The output terminal OT of the flip-flop FFX is connected to a first input terminal of the AND circuit AX7, the output terminal of the OR circuit OY5 is connected to a second input terminal of the AND circuit AX7, and an output terminal of the AND circuit AX7 is connected to the first input terminal of the OR circuit OX4.

The 3-bit down counter BDC-1 further includes OR circuits OY2, OY3, and OY4 output terminals of which are connected to the respective data input terminals D1 of the flip-flops FFY1, FFy2, and FFy3.

The 3-bit down counter BDC-1 further includes AND circuits AY1, AY4, and AY7 respective output terminals of which are connected to the first input terminals of the OR circuits OY2, OY3, and OY4. The output terminal of the OR circuit OX5 is connected to the first input terminals of the AND circuits AY1, AY4, and AY7, and the output terminal of the OR circuit OY5 is connected to the third input terminals of the AND circuits AY1, AY4, and AY7. The 3-bit down counter BDC-1 further includes AND circuits AY2, AY5, and AY8 respective output terminals of which are connected to the second input terminals of the OR circuits OY2, OY3, and OY4. In addition, an output terminal of the OR circuit OX5 is connected to the first input terminals of the AND circuits AY2, AY5, and AY8 via an inverter circuit (represented by a circle in FIG. 11). Further, the respective output terminals OT of the flip-flops FFY1, FFY2, and FFY3 connected via the OR circuits OY2, OY3, and OY4 are connected to the second input terminals of the AND circuits AY2, AY5, and AY8.

The 3-bit down counter BDC-1 further includes AND circuits AY3, AY6, and AY9 respective output terminals of which are connected to the third input terminals of the OR circuits OY2, OY3, and OY4. The output terminal of the AND circuit AX3 connected to the first input terminal of the AND circuits AY3, AY6, and AY9, and the output terminals of the NUM field of the Bit(4:6) of the pseudofault register 112b-2B are connected to the second input terminals of the AND circuits AY3, AY6, and AY9. As a result, when the MODE field indicates reset (MODE=“00”), respective values of the NUM field of the pseudofault register 1112b-2B are directly output from the AND circuits AY3, AY6, and AY9. The values output from the AND circuits AY3, AY6, and AY9 are then set in advance to the flip-flops FFY1, FFY2, and FFY3.

The 3-bit down counter BDC-1 further includes inverter circuits N1, N2, and N3 configured to invert the values output from the flip-flops FFY1, FFY2, and FFY3. The 3-bit down counter BDC-1 further includes exclusive OR circuits EORY1, and EORY2 connected to the respective second input terminals of the AND circuits AY4 and AY7. The 3-bit down counter BDC-1 further includes an OR circuit OY1 an output terminal of which is connected to the first input terminal of the exclusive OR circuit EORY2, and respective input terminals of which are connected to the output terminals of the flip-flops FFY1, FFY2, and FFY3.

The output terminal of the flip-flop FFY1 is connected to the first input terminal of the exclusive OR circuit EORY1, and the output terminal of the inverter circuit N2 is connected to the second input terminal of the exclusive OR circuit EORY1. In addition, the output terminal of the OR circuit OY1 is connected to the first input terminal of the exclusive OR circuit EORY2, and the output terminal of the inverter circuit N3 is connected to the second input terminal of the exclusive OR circuit EORY2.

Next, a description is given of operations of the timer control circuit 112b-1B illustrated in FIG. 11. When the MODE field includes 10 ms or 100 ms intermittent setting, output values of the AND circuits AX1 and AX2 are “0” before 10 ms or 100 ms has elapsed owing to the counting operation of the (n+1) bit up counter BUC-2 similar to that of the timer control circuit 112b-1A illustrated in FIG. 8. The “0” output by the AND circuits AX1 and AX2 are supplied to the AND circuits AY1, AY4, and AY7 via the OR circuit OX5. Hence, the output values of the AND circuits AY1, AY4, and AY7 are “0”. On the other hand, the output value “0” of the OR circuit OX5 is inverted into “0” by the inverter circuits (represented by a circle in FIG. 11). The inverted “1” is then input into the AND circuits AY2, AY5, and AY8. Further, since the MODE field includes 10 ms or 100 ms intermittent setting other than the resetting (MODE=“00”), the output values of the AND circuit AX3 supplied to the AND circuits AY3, AY6, and AY9 are “0”. As a result, the AND circuits AY3, AY6, and AY9 output “0”. Accordingly, the AND circuits AY2, AY5, and AY8 directly output the respective output values of the flip-flops FFY1, FFY2, and FFY3 as they are before 10 ms or 100 ms has elapsed. Then the output values output by the AND circuits AY2, AY5, and AY8 are supplied to the flip-flops FFY1, FFY2, and FFY3 as they are via the OR circuits OY2, OY3, and OY4. As a result, the respective values set to the flip-flops FFY1, FFY2, and FFY3, that is, respective values of the NUM field of the pseudofault register 112b-2B are maintained before 10 ms or 100 ms has elapsed.

Subsequently, the output value of the AND circuit AX1 or AX2 is “1” when 10 ms or 100 ms has elapsed. The “1” output by the AND circuit AX1 or AX2 is supplied to the AND circuits AY1, AY4, and AY7 via the OR circuit OX5. As described above, the respective values of the NUM field of the pseudofault register 112b-2B are set to the flip-flops FFY1, FFY2, and FFY3 when the MODE field are reset (MODE=“00”). When the values of the NUM field are other than “000”, the output value of the OR circuit OY5 is “1”. The output “1” is thus input into the AND circuits AY1, AY4, and AY7. As a result, the AND circuits AY1, AY4, and AY7 directly output the respective output values of the inverter circuit N1, and the exclusive OR circuits EORY1 and EORY2 as they are. Then, the output values output by the AND circuits AY1, AY4, and AY7 are then supplied to the flip-flops FFY1, FFY2, and FFY3 via the OR circuits OY2, OY3, and OY4.

Note that three flip-flops FFY1, FFY2, and FFY3, the inverter circuits N1, N2, and N3, and the exclusive OR circuits EORY1 and EORY2 form the down counter (i.e., the 3-bit down counter BDC-1). The 3-bit down counter BDC-1 counts a counted value down by −1 at timing of a system clock signal −SYS-CLK input into clock input terminals CK of the flip-flops FF1, FF2, and FF3. Accordingly, as described above, in a status where the output values of the inverter circuit N1, and the exclusive OR circuits EORY1 and EORY2 are directly input to the flip-flops FFY1, FFY2, and FFY3, a subtracting operation of the 3-bit down counter BDC-1 may be executed.

The respective values set to the flip-flops FFY1, FFY2, and FFY3, that is, respective values of the NUM field of the pseudofault register 112b-2B are reduced by 1 (i.e., −1) as a result of the execution of the subtracting operation of the 3-bit down counter BDC-1. Thereafter, the value output by the AND circuit AX1 or AX 2 will not be “1”, until the (n+1) bit up counter BUC-2 acquires the maximum value as the counted value CT, is reset, and 10 ms or 100 ms has elapsed again”. Accordingly, the counted value of the 3-bit down counter BDC-1 is maintained during that time (i.e., until the value output by the AND circuit AX1 or AX2 is “1”). When 10 ms or 100 ms has elapsed again, the 3-bit down counter BDC-1 repeats the subtracting operation to subtract the counted value down by −1. As a result of repeating the subtracting operation, the counted value CT of the 3-bit down counter BDC-1 is “0”; that is, the output value of each of the flip-flops FFY1, FFT2, and FFY3 is “0”. As a result, the OR circuit OY5 outputs “0”, which is then input to the AND circuit AX7. Hence, the AND circuit AX7 outputs “0”. As a result, the OR circuit OX4 outputs “0”, and the timer control circuit 112b-1B outputs “0” to suppress the pseudofault from being caused.

The “0” output by the OR circuit OY5 is also input to the AND circuits AY1, AY4, and AY7. Thereafter, even if 10 ms or 100 ms has elapsed, the AND circuits AY1, AY4, and AY7 output “0”. As a result, since the subtracting operation of the 3-bit down counter BDC-1 is stopped and “0” is maintained as the counted value of the 3-bit down counter BDC-1, the pseudofault may continue to be prevented from being caused.

According to the third embodiment, the pseudofault is caused a desired number of times (a designated number of times), which is set to the NUM field of the pseudofault register 112b-2B. Once the pseudofault has been caused the desired number of times, the pseudofault is suppressed from being caused.

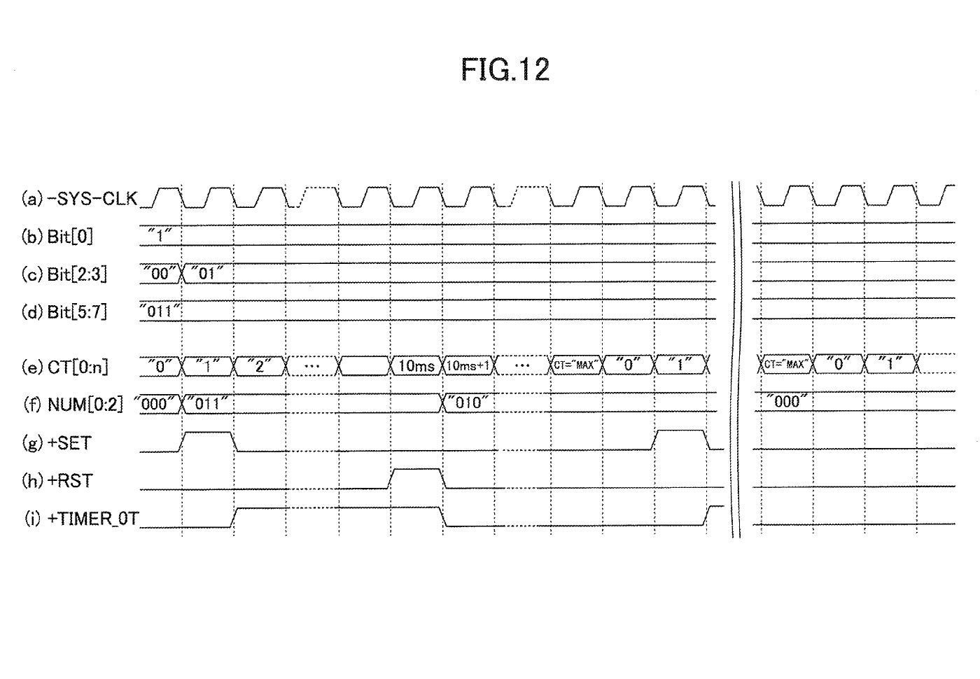

Next, a description is given of an operational example of the timer control circuit 112b-1B in the third embodiment with reference to FIG. 12. In FIG. 12, (a) indicates a waveform of a system clock signal (−SYS-CLK), and (b) indicates an EN bit value of the pseudofault register 112b-2B. Further, (c) indicates setting values of the MODE field (MODE=“00”, “01”, “10”, or “11”), (d) indicates the number of times the pseudofault is caused (a designated number of times), (e) indicates the counted value (CT) of the (n+1) bit up counter BUC-1, (f) indicates the counted value of the 3-bit down counter BDC-1 (down counter), (g) indicates the output value (+SET) of the AND circuit AX5, (h) indicates the output value (+RST) of the OR circuit OX2, and (g) indicates an output value (+TIME_OT) of the OR circuit OX4, that is, an output value of the timer control circuit 112b-1B.

In the example in FIG. 12, 10 ms intermittent setting (MODE=“01”) is set to the MODE field as an example. Further, “3 times” (NUM=“011”) is set to the NUM field (see (d) in FIG. 12), which indicates the number of times the pseudofault is caused (i.e., the desired number of times). When the (n+1) bit up counter BUC-2 starts the counting operation, the AND circuit AX 5 outputs “1” (+SET) ((g)), and the Flip-Flop FFX outputs “1” at a timing of the counted value CT=“1” similar to the operational example illustrated in FIG. 9. Note that, the designated number of times set to each of the flip-flops FFY1, FFY2, and FFY3 is three times (i.e., NUM=“011”). Thus, since the value of the NUM is other than “0”, the OR circuit OY5 outputs “1”, and the AND circuit AX7 outputs “1”. As a result, the OR circuit OX4 outputs “1” (+TIMER_OT), and the timer control circuit 112b-1B outputs “1”, thereby suppressing the pseudofault from being caused.

Thereafter, the pseudofault is prevented from being caused while “1” is maintained as the output value (+TIMER_OT) of the timer control circuit 112b-1B until 10 ms has elapsed. When 10 ms has elapsed, the AND circuit AX1 outputs “1”. As a result, the OR circuit OX2 outputs “1” (+RST), which is inverted into “0” by the inverter circuit (represented by a circle in FIG. 12). The inverted “0” is then input into the flip-flop FFX, similar to the operational example illustrated in FIG. 9. As a result, the flip-flop FFX outputs “0”, “0” is maintained as the output value (+TIMER_OT) of the timer control circuit 112b-1B, and the counted value of the 3-bit down counter BDC-1 is reduced by 1 (i.e., −1), until the counted value of the (n+1) bit up counter BUC-2 acquires “CT=1” again after allowing the (n+1) bit up counter BUC-2 to reach the maximum value and is then reset. When the counted value CT=“1” again, the output value (+TIMER_OT) of the timer control circuit 112b-1B is “1” as a result of an operation similar to the above-described operation.

Accordingly, the operations performed by the timer control circuit 112b-1B in the third embodiment may differ from those in an operational environment as follows (excluding setting time of the intermittent setting). That is, the pseudofault causing operation is interrupted, and the counted value of the 3-bit down counter BDC-1 is reduced by 1 (i.e., “011”→“010”→“001”→“000”) every time the counting operation of the (n+1) bit up counter BUC-2 indicates that 10 ms has elapsed.

As a result of the subtraction of the counted value of the 3-bit down counter BDC-1, when the counted value is “0”, “0” is maintained as the output value of the timer control circuit 112b-1B, the pseudofault is prevented from being caused thereafter. As a result, in the operational example illustrated in FIG. 12, the pseucofault causing operation is intermittently executed three times (i.e., the designated number of times), and the pseudofault is prevented from being caused thereafter.

FIG. 13 illustrates a configuration example of the information processing apparatus 1000B according to the third embodiment. The information processing apparatus 1000B illustrated in FIG. 13 includes a configuration having parts similar to those of the configuration of the information processing apparatus illustrated in FIG. 6. Hence, in FIG. 13, those parts that are the same as those corresponding parts in FIG. 6 are designated by the same reference numerals, and a duplicated description thereof will appropriately be omitted.

The information processing apparatus 1000B illustrated in FIG. 13 includes a testing target printed circuit board 110B having a thermistor TH-1 and a sender unit 110B, a receiver unit 120B, a system console interface (SCI) 200, and a service processor SVP 300. In addition, the sender unit 110B includes a buffer IBX configured to amplify an output value of the thermistor TH-1, an analog-to-digital converter (ADC) ADC-1, a slip circuit 113-1, an information processor (internal logic) LG1, a JTAG-interface (JTAG-IF) 111, and an EG generating circuit 112bB. The information processor LG-1 includes a serial-to-parallel interface (SPI) SPI-1. In addition, the sender unit 120B includes an information processor LG-2 and a microprocessor unit (MPU) MPU-1.

The thermistor TH-1 serves as a temperature sensor configured to detect an exhaust air temperature or an intake air temperature of the information processing apparatus 100B. In addition, the receiver unit 120B serves as a system power controller (SPC) configured to control power of the information processing apparatus 1000B. Further, the sender unit 110B serves as an extension unit of the SPC (i.e., the receiver unit 120B); that is, the sender unit 110B serves as a system power controller extender (SPCE) having a function to extend the number of controllers that control the power or sensors of the information processing apparatus 1000B.

The SPCE serving as the sender unit 110B is configured to allow the buffer IBX to amplify the output signal of the thermistor TH-1, and allow the ADC1 to convert the amplified output signal into a digital signal. Further, the SPCE is configured to combine an output signal of another not-illustrated temperature sensor with the converted digital signal, allow the SPI-1 to convert the combined signal into a serial signal, and then output the converted serial signal to the receiver unit 120B.

Note that when the thermistor TH-1 serves as an exhaust air temperature sensor configured to change an output voltage based on an exhaust air temperature, the SPC serving as the receiver unit 120B performs the following operation. The SPC serving as the receiver unit 120B monitors the presence or absence of a disconnection (open circuit) status or a short (short circuit) status based on the signal received from the SPCE serving as the sender unit 110B in a period from a system power on to a system power off of the information processing apparatus 1000B. Then, when a signal level indicating the open circuit status or the short circuit status of the output signal of the internal logic LG-1 continues for 32 ms to 64 ms (a threshold value), the SPC serving as the receiver unit 120B detects the exhaust air temperature as abnormal, interrupts an operation of the MPU-1, and executes a system alarm disconnection process to power off the system. The SPC serving as the receiver unit 120B then reports to the SVP 300 a flag code corresponding to an abnormal exhaust air temperature. Note that the SVP 300 has a power supply the same as the power supply of the system, and displays a flag code at the disconnecting of the power the next time the power is supplied to the system.

Further, when the thermistor TH-1 serves as an intake air temperature sensor configured to change an output voltage based on an intake air temperature, the SPC serving as the receiver unit 120B performs the following operation. The SPC serving as the receiver unit 120B determines an output voltage of the intake air temperature sensor at intervals of a second based on a signal received from the SPCE serving as the sender unit 110B. The SPC determines the intake temperature as abnormal, and reports a flag code corresponding to the intake temperature to the SVP 300 when the output voltage of the intake air temperature sensor exhibits an abnormal intake air temperature three consecutive times. The SPC then performs control to increase the rotational speed of a fan incorporated in the image processing apparatus 1000B.

Note that when the thermistor TH-1 serves as the exhaust air temperature sensor to change an output voltage based on an exhaust air temperature, the SPC sets a 10 ms (MODE=“01”) or 100 ms (MODE=“10”) intermittent setting to the MODE field of the pseudofault register 112b-2B. Further, “once” (NUM=“001”) is set to the NUM field, which specifies the number of times the pseudofault is caused (the desired number of times). As a result, the timer control circuit 112b-1B performs control on the clip circuit 113-1 to clip the output value (+SENSOR OUT) of the thermistor TH-1 serving as the exhaust air sensor at “0” or “1”, thereby generating the pseudo-abnormal temperature. Further, the output value of the thermistor TH-1 may be clipped at “0” or “1” only once in 10 ms or only once in 100 ms. As a result, the open circuit status or the short circuit status due to the above pseudo-abnormal temperature may be caused once in 10 ms that is a duration less than the threshold range of 32 to 64 ms or 100 ms that is a duration exceeding the threshold range of 32 to 64 ms.

Further when the thermistor TH-1 serves as the intake air temperature sensor, the SPC may, for example, set a 10 ms (MODE=“01”) intermittent setting to the MODE field of the pseudofault register 112b-2B and may set “three times” (NUM=“011”) or “four times” (NUM=“011”) to the NUM field designating the number of times. As a result, the timer control circuit 112b-1B causes the open circuit status or the short circuit status three (within the threshold) or four (exceeding the threshold) consecutive times due to the pseudo-abnormal temperature indicating the abnormal intake air temperature.

Hence, according to the third embodiment, two assessment conditions including a case within the threshold and a case exceeding the threshold may be assessed with respect to the case employing the BBC tester for assessing the monitoring function to monitor the exhaust air temperature sensor or the intake air temperature sensor. Accordingly, the monitoring function may simply and reliably be verified.

### Fourth Embodiment

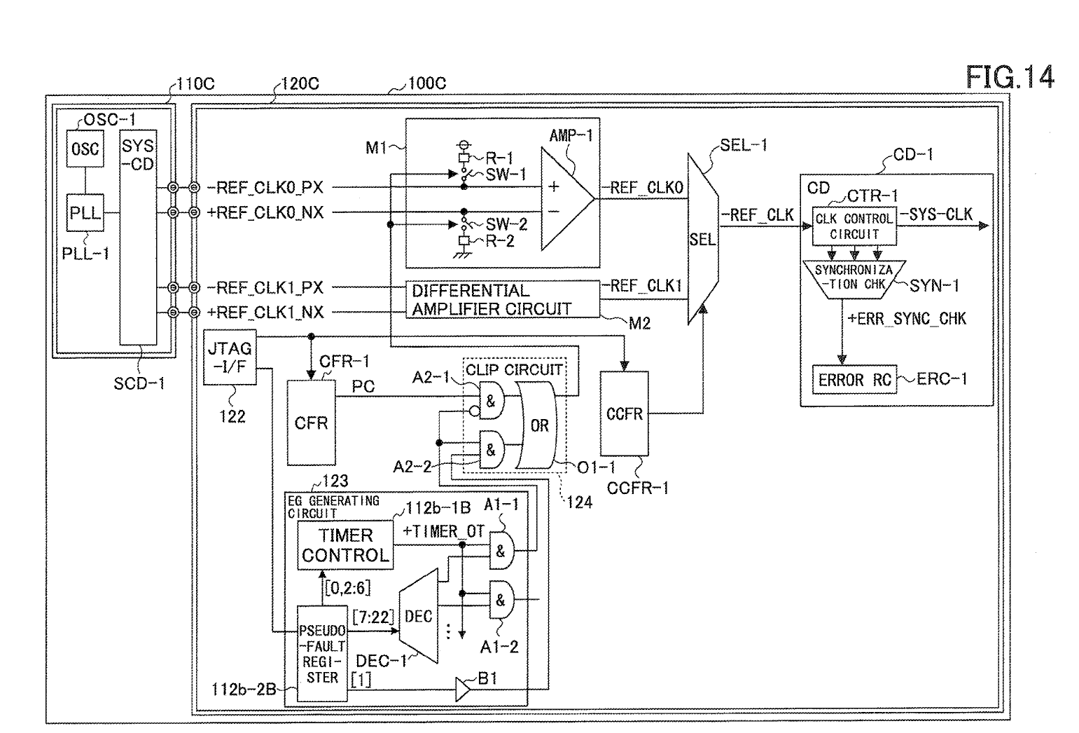

Next, a description is given of a fourth embodiment with reference to FIGS. 14 to 17. FIG. 14 illustrates a configuration of a testing target printed circuit board 100C implementing a pseudofault causing method according to a fourth embodiment. The testing target printed circuit board 100C illustrated in FIG. 14 includes a sender unit 110C and a receiver unit 120C.

The testing target printed circuit board 100C may be tested by the SCI disposed inside the not-illustrated information processing apparatus by utilizing a JTAG interface and operations of the testing target printed circuit board 100C may be monitored by SVP in a manner similar to a case of the first embodiment illustrated in FIG. 4.

The receiver unit 120C includes an oscillator circuit OSC-1 configured to generate a system clock signal in a power on reset (PON-RESET) procedure which is conducted when system power of the information processing apparatus is turned on (supplied). The PON-RESET procedure includes a procedure to reset the system when the system power is turned on (supplied). The sender unit 110C further includes a phase locked loop PLL-1 configured to oscillate a system clock signal at a desired frequency and a system clock distributor CD-1 (SYS-CD1). The SYS-CD CD-1 serves as a circuit having a function to distribute the system clock signal output from the PLL PLL-1. In an example of FIG. 14, the SYS-CD CD-1 supplies a reference clock signal serving as dual differential signals to the receiver unit 120C mounted on the testing target printed circuit board 100C. In this configuration, by transmitting the differential signals, two signals having mutually opposite phases may be sent with respect to one signal by utilizing two signal lines such that the receiver unit may acquire the difference between the two signal voltages. Hence, durability against extraneous noise may be improved higher than that in a case of sending a single-phase (single-end) signal.

The receiver unit 120C amplifies the above-described dual reference clock signals in respective differential amplifier circuits M1 and M2, and supplies the reference clock signals −REF_CLK0 and −REF_CLK1 serving as the amplified differential signals to a selector SEL-1. The differential amplifier circuit M1 includes a differential amplifier AMP-1, a pull-up terminating resistor R-1, a switch SW-1, a pull-down terminating resistor R-2, and a switch SW-2. Note that the differential amplifier circuit M2 has a circuit configuration similar to that of the differential amplifier circuit M1.

The receiver unit 120C further includes a joint test action group interface (JTAG-IF) 122, a register configuration register (CFR) CFR-1, a register (a clock configuration register) CCFR-1, an EG generating circuit 123, and a clip circuit 124. Note that the JTAG-IF 122, the EG generating circuit 123, and the clip circuit 124 have configurations similar to those of the JTAG-IF 111, the EG generating circuit 122bB, and the clip circuit 113-1 illustrated in FIG. 13.

To enable the pull-up terminating resistor R-1 and the pull-down terminating resistor R-2 of the differential amplifier circuit M1, PC=“1” is set to the register CFR-1 via the JTAG-IF 122. As a result, a signal indicating the PC=“1” is supplied to the switches SW-1 and SW2 via the clip circuit 124 to switch the switches SW-1 and SW2 to on. As a result, a signal line −REF_CLK0_PX of the reference signal serving as the differential signal is connected to the power supply via the pull-up terminating resistor R-1. Likewise, a signal line −REF_CLK0_NX of the reference signal serving as the differential signal is grounded via the pull-down terminating resistor R-2. The signal reflection may be prevented and signal transmission with little waveform fluctuation may be achieved by disposing the pull-up terminating resistor R-1 and the pull-down terminating resistor R-2 on terminating sides of the wiring.

Note that when the output of the differential amplifier circuit M1 is not selected by the selector SEL-1 and hence the reference clock signal output from the differential amplifier circuit M1 is unused, neither the pull-up terminating resistor R-1 nor the pull-down terminating resistor R-2 may be required. In this case, PC=“0” is set to the register CFR-1 via the JTAG-IF 122. As a result, switches SW-1 and SW-2 are in an off status (i.e., the open circuit status) to disconnect the circuits of the pull-up terminating resistor R-1 and the pull-down terminating resistor R-2. Accordingly, the pull-up terminating resistor R-1 and the pull-down terminating resistor R-2 are unused.

The selector SEL-1 is configured to select one of the reference clock signals output from the differential amplifier circuits M1 and M2 based on the setting of the register CCFR-1 set via the JTAG-IF 122. The negative logic reference clock signal −REF_CLK selected by the selector SEL-1 is supplied to a clock distribute (CD) CD-1, such that a clock (CLK) control circuit CTR-1 of the CD CD-1 distributes a negative logic system clock signal −SYS-CLK to not illustrated circuits or the like within the testing target printed circuit board 100C. The CD CD-1 serves as a circuit configured to distribute the system clock signal −SYS-CLK. Further, the clock control circuit CTR-1 and a synchronization check circuit SYN-1 may serve as a function to determine whether the fluctuation is present in the waveform of the reference clock signal −REF_CLK. When the determination result given by the clock control circuit CTR-1 and a synchronization check circuit SYN-1 is an error, the error information (region code) is stored in a storage device ERC-1.

Further, the functions of the EG generating circuit 123 and the clip circuit 124 may clip the outputs from CFR CFR-1 to switches SW-1 and SW-2 to cause a pseudofault. It is assumed a case in which the switches SW-1 and SW-2 are switched on according to the setting PC=“1” to CFR CFR-1 to enable the pull-up terminating resistor R-1 and the pull-down terminating resistor R-2. In this case, the pseudofault is caused by clipping of the output of the CFR CFR-1, which changes the setting PC=“1” into the setting PC=“0” in a pseudo changing manner. As a result, the pull-up terminating resistor R-1 and the pull-down terminating resistor R-2 are detached from the respective reference clock signal lines −REF_CLK0_PX and −REF_CLK0_NX. As a result, the waveform of the reference clock signal transferred form the sender unit 110C to the receiver unit 120C may fluctuate, and hence, the waveform of the reference clock signal −REF_CLK supplied to the CD CD-1 via the differential amplifier circuit M1 may fluctuate. As a result, the synchronization check circuit SYN-1 detects an error based on the fluctuation of the waveform of the reference clock signal −REF_CLK. Note that the output of the CFR CFR-1 is also sent via the clip circuit 124 to the switches that enable the not illustrated pull-up terminating resistor R-1 and pull-down terminating resistor R-2 of the differential amplifier circuit M2. The clip circuit may, for example, be controlled by the AND circuit A1-2 of the EG generating circuit 123 in a manner similar to the clip circuit 1132 illustrated in FIG. 4.

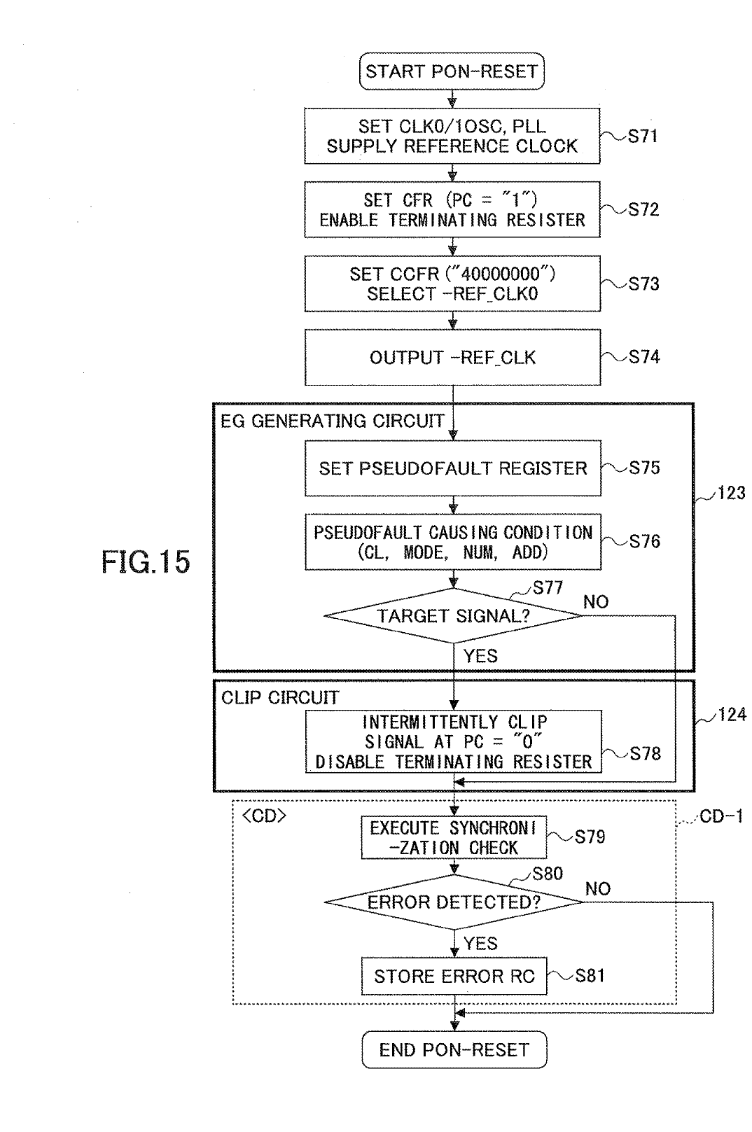

FIG. 15 is a flowchart illustrating an operational flow of a pseudofault causing method according to a fourth embodiment. In step S71, a clock signal generated by the sender unit 110C is determined, and the OSC OSC-1 and the PLL PLL-1 are set. Subsequently, in step S72, the register CFR-1 (PC=“1”) is set by the JTAG-IF 122 conducting scanning setting. Then, in step S73, the register CCFR-1 is set by the JTAG-IF 122 conducting scanning setting in a similar manner as the scanning setting performed on the register CFR-1. The register CCFR-1 is the setting for the selector SEL-1 to select the reference clock signal output from the differential amplifier circuit M1.

Subsequently, in step S74, the sender unit 110C sends the reference clock signal −REF_CLK to the receiver unit 120C. Then, in step S75, the pseudofault register 112b-2B is set by the JTAG-IF 122 conducting scanning setting. Then, in step S76, the setting value of the pseudofault register 112b-2B is read by the timer control circuit 112b-1B, the decoder DEC-1, and the clip circuit 124. As a result of reading the setting value of the pseudofault register 112b-2B, when the output of the register CFR-1 is subject to causing the pseudofault to which “1” is input from the decoder circuit DEC-1 (“YES” in step S77), step S78 is executed. On the other hand, when the output of the register CFR-1 is not subject to causing the pseudofault (“NO” in step S77), step S79 is executed.

In step S78, the clip circuit 124 clips the output of the register CFR-1 based on a manner (e.g., intermittent setting) corresponding to the setting of the pseudofault register 112b-2B. In step S79, the synchronization checks circuit SYN-1 checks the reference clock signal −REF_CLK. As a result the check performed by the synchronization check circuit SYN-1, when an error is detected based on the fluctuation of the waveform of the reference clock signal −REF_CLK (“YES” in step S80), the detected result is stored (step S81). On the other hand, as a result the check performed by the synchronization check circuit SYN-1, when an error is not detected based on the fluctuation of the waveform of the reference clock signal −REF_CLK (i.e., when no fluctuation of the waveform of the reference clock signal −REF_CLK is detected) (“NO” in step S80), the process is terminated.

In the pseudofault causing method according to the BBC tester, signals are randomly clipped. Hence, the above-described error will not be caused by the above-described clipping process at a system power-on state unless the reference clock signal −REF_CLK has already been transferred to the receiver unit 120C. According to the above-described fourth embodiment, the pseudofault register 112b-2B is set by the JTAG-IF 122 at a desired timing (step S75 in FIG. 15). Accordingly, the pseudofault may be able to be reliably caused at a timing after the reference clock signal −REF_CLK has already been transferred to the receiver unit 120C. Thus, a check function of the synchronization check circuit SYN-1 may reliably verified.

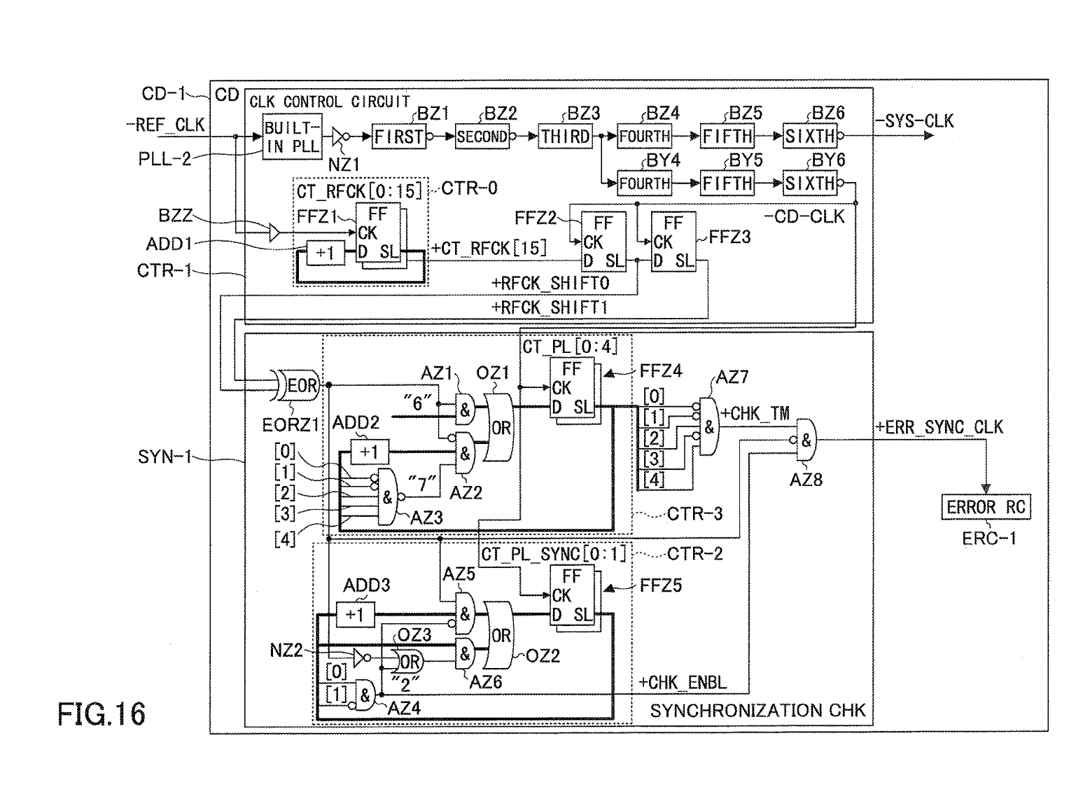

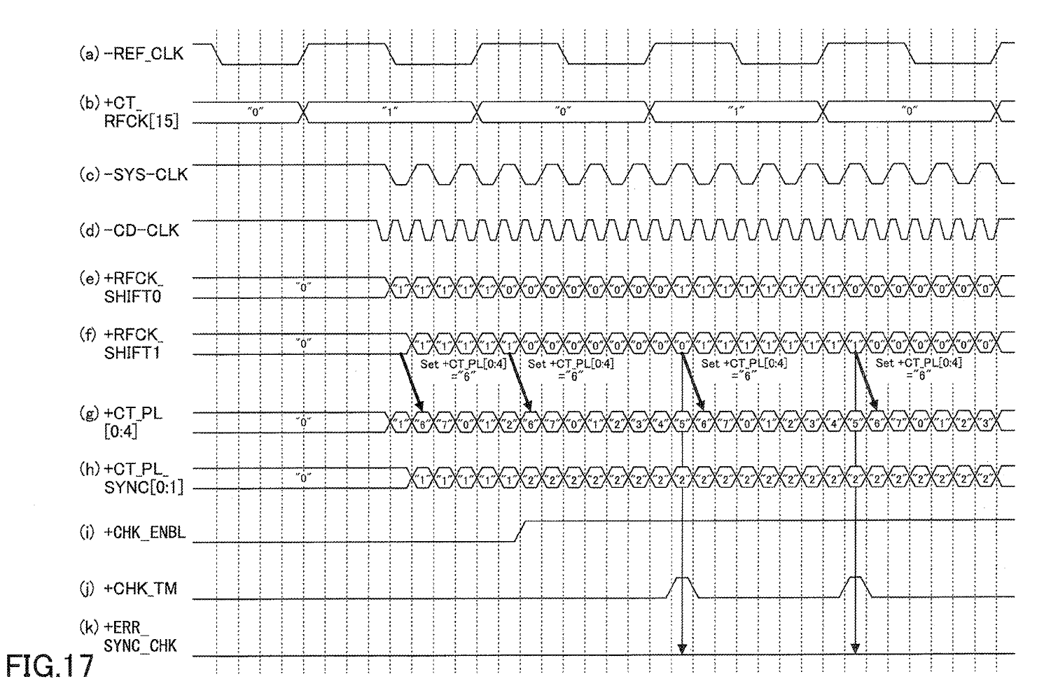

Next, a description is given of a circuit configuration example and an operational example of the CD CD-1 illustrated in FIG. 14 together with reference to FIGS. 16 and 17. The clock control circuit CTR-1 includes a PLL-2 serving as a built-in PLL, an inverter circuit NZ1, distribution circuit buffers BZ1, BZ2, BZ3, BZ4, BZ5, BY4 and BY5, and copper circuits BZ6 and BY6. The PLL PLL-2 is configured to multiply the reference clock signal supplied from the selector SEL-1, and the inverter circuit NZ1 is configured to invert the multiplied reference clock signal. The distribution circuit buffers BZ1, BZ2, BZ3, BZ4, BZ5, BY4 and BY5, and the chopper circuits BZ6 and BY6 generate a clock signal chopped into a predetermined width based on the reference clock signal −REF_CLK, a signal having an inverted phase of the reference clock signal −REF_CLK, and supply the generated chopped clock signal pieces to not illustrated circuits or components mounted on the testing target printed circuit board 100C. Note that the generated chopped clock signal pieces may optionally be inverted and then supplied to the circuits or components mounted on the testing target printed circuit board 100C.

The clock control circuit CTR-1 further includes a buffer BZZ, a 16-bit counter CTR-0, and flip-flops FFZ2 and FFZ3. The 16-bit counter CTR-0 includes a multi-bit holding circuit FFZ1 formed of a flip-flop, and an adder ADD1. The reference clock signal supplied from the selector SEL-1 is transmitted to the buffer BZZ, which is then input to the 16-bit counter CTR-0. The 16-bit counter CTR-0 counts a value of a least significant bit (LSB)+CT_RFCK(15) by +1 at a timing of the reference clock signal −REF_CLK input from the buffer BZZ, and outputs the value of the least significant bit (LSB)+CT_RFCK(15) to a data input terminal D of the flip-flop FFZ2. Note that a higher bit of the 16-bit counter CTR-0 may be applied to other uses. The output of the flip-flop FFZ2 is output to the data input terminal D of the flip-flop FFZ3. The clock signal −CD-CLK output from the chopper circuit BY6 is supplied to the clock input terminals of the flip-flops FFZ2 and FFZ3, so that the values of the signals input to the data input terminals D of the flip-flops FFZ2 and FFZ3 are acquired at the timing of the supplied clock signal −CD-CLK.

In FIG. 17, (a) represents a waveform of the reference clock signal −REF_CLK supplied from the selector SEL-1, (b) represents the value of the least significant bit (LSB)+CT_RFCK(15) of the 16-bit counter CTR-0, and (c) represents a waveform of the system clock signal −SYS-CLK output from the chopper circuit BZ6. In addition, (d) represents a waveform of the clock signal −CD-CLK supplied to each of the flip-flops FFZ2 and FFZ3, and (e) represents a waveform of a signal +RFCK_SHIFT0 output by the flip-flop FFZ2. Further, (f) represents a signal +RFCK_SHIFT1 output by the flip-flop FFZ3.

As illustrated in (e) and (f) in FIG. 17, the output values of the flip-flops FFZ2 and FFZ3 are inverted at a timing of inverting the value of the least significant bit +CT_RFCK(15) of the 16-bit counter CTR-0; that is, the output values of the flip-flops FFZ2 and FFZ3 are inverted for every cycle of the reference clock signal −REF_CLK. In this case, the timing at which the respective output values of the flip-flops FF2 and FFZ3 are inverted is as follows. That is, when the output value of the flip-flop FFZ2 is inverted from 0 to 1, or 1 to 0, the output value of the flip-flop FFZ3 is likewise inverted from 0 to 1, or 1 to 0 at a subsequent timing of the clock signal −CD-CLK. As a result, there occurs timing of a clock signal −CD-CLK at which the output values of the flip-flops FFZ2 and FFZ3 do not match for every cycle of the reference clock signal −REF_CLK (see (e) and (f) FIG. 17). Further, the output values of the flip-flops FFZ2 and DDZ3 match at the timing of the clock signal −CD-CLK other than the above timing. Note that as illustrated in FIG. 17, the frequency of the clock signal −CD-CLK in (d) is eight times higher than the frequency of the reference clock signal −REF_CLK in (a).

The synchronization check circuit SYN-1 includes an exclusive OR EORZ1 an input terminal of which receives the respective output values of the flip-flops FFZ2 and FFZ3, and a 5-bit down counter CTR-3. The 5-bit down counter CTR-3 includes a multi-bit gate circuits AZ1 and AZ2 having an AND circuit adapted to plural bits, a multi-bit gate circuit OZ1 having an OR circuit adapted to plural bits, and a multi-bit holding circuit FFZ4 formed of a flip-flop. Note that the 5-bit counter CTR-3 further includes an adder ADD2 and a NAND circuit AZ3 (NOT-AND gate). Note that (g) in FIG. 17 indicates an output value of the 5-bit counter CTR-3.

The 5-bit counter CTR-3 operates as follows. When the output values of the flip-flops FFZ2 and FFZ3 do not match, the exclusive OR EORZ1 outputs 1, which is then input into one of the input terminals of the multi-bit gate circuit AZ1 having the AND circuit adapted to plural bits. As a result, the multi-bit gate circuit AZ1 having the AND circuit adapted to plural bits outputs data indicating “6” input to the other input terminal. The data indicating “6” is input into the multi-bit holding circuit FFZ4 formed of the flip-flop via the multi-bit gate circuit OZ1 having the OR circuit adapted to plural bits, and the data indicating “6” input into the multi-bit holding circuit FFZ4 is then set as a counted value of the 5-bit down counter CTR-3. Accordingly, as illustrated in (d), (e), (f), and (g) of FIG. 17, “6” is set to as the counted value (output value) of the 5-bit counter CTR-3 at the timing subsequent to the timing of the clock signal −CD-CLK at which the output values of the flip-flops FFZ2 and FFZ3 do not match.

On the other hand, at the timing of the clock signal −CD-CLK at which the output values of the flip-flops FFZ2 and FFZ3 match, since the exclusive OR EORZ1 outputs 0, the multi-bit gate circuit AZ1 having the AND circuit adapted to plural bits outputs “0”. On the other hand, a first input terminal of the multi-bit gate circuit AZ2 having the AND circuit adapted to plural bits is supplied with “1” that is inverted by the inverter circuit (represented by a circle in FIG. 16) from “0” output from the exclusive OR circuit ORZ1. Further, “0” is supplied from the NAND circuit AZ3 to a third input terminal of the multi-bit gate circuit AZ2 having the AND circuit adapted to plural bits only when the counted value of the 5-bit counter CTR-3 is “7”.

As a result, when the counted value of the 5-bit counter CTR-3 is other than “7” at the timing of the clock signal −CD-CLK at which the output values of the flip-flops FFZ2 and FFZ3 match, the multi-bit gate circuit AZ1 having the AND circuit adapted to plural bits outputs “0”. That is, the multi-bit gate circuit AZ1 having the AND circuit adapted to plural bits outputs “0” that is obtained by the adder ADD2 adding “1” to the counted value. The output value “1” is then set to the multi-bit holding circuit FFZ4 formed of the flip-flop via the multi-bit gate circuit OZ1 having the OR circuit adapted to plural bits. That is, the 5-bit counter CTR-3 counts by +1.

On the other hand, when the counted value is “7”, the output value of the multi-bit gate circuit AZ2 having an AND circuit adapted to plural bits is “0”, which is then set to the multi-bit holding circuit FFZ4 formed of a flip-flop via the multi-bit gate circuit OZ1 having an OR circuit adapted to plural bits. That is, the counted value of the 5-bit counter CTR-3 is reset to 0.

Accordingly, the counted value of the 5-bit counter CTR-3 is sequentially incremented by +1 at the timing of the clock signal −CD-CLK at which the output values of the flip-flops FFZ2 and DDZ3 match. However, the counted value of the 5-bit counter CTR-3 is “6” at the timing of the clock signal −CD-CLK at which the output values of the flip-flops FFZ2 and FFZ3 do not match. Then, when the counted value of the 5-bit counter CTR-3 is “7”, the counted value is reset to “0”.

Accordingly, as illustrated in FIG. 17, after the PLL PLL-2 starts oscillating and subsequently generates a clock signal −CD-CLK (d) based on the reference clock signal −REF_CLK (a), the 5-bit counter CTR-3 performs the following operations. That is, when the output value of the flip-flop FFZ2 is initially inverted from 0 to 1, or 1 by receiving the value “1” of the least significant bit +CT_RFCK(15) of the 16-bit counter CTR-0, the output value of the flip-flop FFZ3 is inverted from 0 to 1 at a subsequent timing of the clock signal −CD-CLK. At this moment, the counted value of the 5-bit counter CTR-3 is set to “6” at the timing of the clock signal −CD-CLK at which the output values of the flip-flops FFZ2 and FFZ3 do not match. Then, when the counted value of the 5-bit counter CTR-3 is sequentially incremented by +1 to reach “7” at the subsequent timing of the clock signal −CD-CLK, the counted value of the 5-bit counter CTR-3 is reset to “0”. Thereafter, the 5-bit counter CTR-3 starts incrementing by +1 again from “0”.

Subsequently, when the value “1” of the least significant bit +CT_RFCK(15) of the 16-bit counter CTR-0 is inverted into “0”, the output value of the flip-flop FFZ2 is inverted from “1” to “0”. At this moment, the counted value of the 5-bit counter CTR-3 is set to “6” at the timing of the clock signal −CD-CLK at which the output values of the flip-flops FFZ2 and FFZ3 do not match at a subsequent timing of the clock signal −CD-CLK. Then, when the counted value of the 5-bit counter CTR-3 is sequentially incremented by +1 to reach “7” at the subsequent timing of the clock signal −CD-CLK, the counted value of the 5-bit counter CTR-3 is reset to “0”. Thereafter, the 5-bit counter CTR-3 starts incrementing by +1 again from “0”.

That is, the output values of the flip-flops FFZ2 are sequentially inverted according to the inversion of the least significant bit +CT_RFCK(15) of the 16-bit counter CTR-0. As a result, the counted value of the 5-bit counter CTR-3 set to “6”. Thereafter, the operations including sequentially inverting the output values of the flip-flops FFZ2 according to the inversion of the least significant bit +CT_RFCK(15) of the 16-bit counter CTR-0, and setting the counted value of the 5-bit counter CTR-3 to “6” are repeatedly conducted. The repeating cycle corresponds to an inverting cycle of the least significant bit +CT_RFCK(15) of the 16 bit counter CTR-0. That is, the repeating cycle is identical to the cycle of the reference clock signal −REF_CLK.

Further, the following operations may be performed after setting of the counted value of the 5-bit counter CTR-3 to “6”. As illustrated in FIG. 17, a timing of setting the counted value of the 5-bit counter CTR-3 to “6” according to the inversion of the least significant bit +CT_RFCK(15) of the 16-bit counter CTR-0 matches a timing of the counted value of the 5-bit counter CTR-3 reaching “6” obtained by incrementing the counted value by +1. Accordingly, the following operations may be repeated (see (g) in FIG. 17). That is, the 5-bit counter CTR-3 sequentially increments the counted value by +1 from “0” to “7”, and when the counted value of the 5-bit counter CTR-3 reaches “7”, the counted value of the 5-bit counter CTR-3 is reset to “0”.

Further, the output terminal of the 5-bit down counter CTR-3 is connected to the AND circuit AZ7. Hence, the AND circuit AZ7 outputs “1” when the counted value of the 5-bit down counter CTR-3 reaches “7”. As a result, the AND circuit AZ7 output “1” (+CHK_TM) at the timing of the clock signal −CD-CLK immediately before the counted value of the 5-bit counter CTR-3 reaches “6. Accordingly, the AND circuit AZ7 performs the following operations after setting of the counted value of the 5-bit counter CTR-3 to “6” according to the inversion of the least significant bit +CT_RFCK(15) of the 16-bit counter CTR-0. That is, the AND circuit AZ7 outputs “1” ((j): +CHK_TM) at the timing of the clock signal −CD-CLK at which the output values of the flip-flops FFZ2 and FFZ3 do not match.

The synchronization check circuit SYN-1 further includes a 2-bit counter CTR-2. The 2-bit counter CTR-2 includes a multi-bit holding circuit FFZ5 formed of a flip-flop, a multi-bit gate circuit OZ2 having an OR circuit adapted to plural bits, and multi-bit gate circuits AZ5 and AZ6 each having an AND circuit adapted to plural bits. The 2-bit counter CTR-2 further includes an adder ADD3, an OR circuit OZ3, and inverter circuits NZ2 and NZ4. The 2-bit counter CTR-2 performs the following operations.

When the output values of the flip-flops FFZ2 and FFZ3 do not match, the exclusive ORZ1 acquires “1”, which is then input to the first input terminal of the multi-bit gate circuit AZ5 having an AND circuit adapted to plural bits. On the other hand, the output value of the AND circuit AZ4 is input to a third input terminal of the multi-bit gate circuit AZ5 having the AND circuit adapted to plural bits. When the counted value of the 2-bit counter is “2”, the AND circuit AZ4 outputs “1”, which is then inverted by an inverter circuit (represented by a circle in FIG. 16) into “0” to be input to the multi-bit gate circuit AZ5 having the AND circuit adapted to plural bits. Further, the value obtained by the adder ADD3 adding +1 to the counted value of the 2-bit counter CTR-2 is supplied to a second input terminal of the multi-bit gate circuit AZ5 having the AND circuit adapted to plural bits.

Accordingly, the multi-bit gate circuit AZ5 having the AND circuit adapted to plural bits outputs the value obtained by the adder ADD3 adding +1 to the counted value of the 2-bit counter CTR-2 every time the output values of the flip-flops FFZ2 and FFZ3 do not match, until the counted value of the 2-bit counter CTR-2 is “2”. The value obtained by the adder ADD3 adding +1 to the counted value of the 2-bit counter CTR-2 is then set to the multi-bit holding circuit FFZ5 formed of the flip-flop via the multi-bit gate circuit OZ2 having the OR circuit adapted to plural bits. That is, the 2-bit counter CTR-2 is sequentially incremented by +1.

Further, the counted value of the 2-bit counter CTR-2 is input to a first input terminal of the multi-bit gate circuit AZ6 having the AND circuit adapted to plural bits, and the output value of the OR circuit OZ3 is input to a second input terminal of the multi-bit gate circuit AZ6. The value obtained by the inverter circuit NZ2 inverting the output value of the exclusive OR circuit EORZ1 is input to a first input terminal of the OR circuit OZ3, and the output value of the AND circuit AZ4 is input to a second input terminal of the OR circuit OZ3.

Accordingly, the multi-bit gate circuit AZ6 having the AND circuit adapted to plural bits outputs the counted value of the 2-bit counter CRT-2 when the output values of the flip-flops FFZ2 and FFZ3 match, or when the counted value of the 2-bit counter CTR-2 is “2”. The output value of the multi-bit gate circuit AZ6 is then input to the multi-bit holding circuit FFZ5 formed of the flip-flop via the multi-bit gate circuit OZ2 having the OR circuit adapted to plural bits. Accordingly, the multi-bit gate circuit AZ6 having the AND circuit adapted to plural bits provides a function to maintain the counted value of the 2-bit counter CRT-2 when the output values of the flip-flops FFZ2 and FFZ3 match, or when the counted value of the 2-bit counter CTR-2 is “2”.

As a result, the 2-bit counter CTR-2 increments the counted value by +1 every time the output values of the flip-flops FFZ2 and FFZ3 do not match, whereas the 2-bit counter CTR-2 maintains the counted value every time the output values of the flip-flops FFZ2 and FFZ3 match. Then, when the counted value of the 2-bit counter CTR-2 is “2”, the 2-bit counter CTR-2 maintains the counted value as “2” thereafter.

The synchronization check circuit SYN-1 further includes an AND AZ8. The following values may be input to the respective input terminals of the AND circuit AZ8. That is, the values obtained by the inverter circuits (represented by a circle in FIG. 16) inverting the output value of the AND circuit AZ7 and the output value of the exclusive OR circuit EORZ1, and the output value of the AND circuit AZ4 are input into the input terminals of the AND circuit AZ8, respectively. In FIG. 17, (h) indicates the counted value of the 2-bit counter CTR-2, (i) indicates the output value (+CHK_ENBL) of the AND circuit AZ4, (j) indicates the output value (+CHK_TM) of the AND circuit AZ7. In addition, (k) indicates the output value (+ERR_SYNC_CHK) of the AND circuit AZ8, that is, the output value of the synchronization check circuit SYN-1.

As illustrated in FIG. 17, the 2-bit counter CTR-2 increments the counted value by +1 every time the output values of the flip-flops FFZ2 and FFZ3 do not match, and the output value ((i): +CHK_ENBL) of the AND circuit AZ4 acquires “1” when the counted value of the 2-bit counter CTR-2 counts “2”. Further, when the counted value (g) of the 5-bit counter CTR-3 count is “5”, and the output values (e) and (f) of the flip-flops FFZ2 and FFZ3 match, “1” is input into all the three input terminal of the AND circuit AZ8, and therefore, the output value of the AND circuit AZ8 is “1”.

When there is no fluctuation in the waveform of the reference clock signal −REF_CLK (a), the output values of the flip-flops FFZ2 and FFZ3 do not match at timing of the output value of the AND circuit AZ4 being “1” and the counted value of the 5-bit counter CTR-3 being “5”. Accordingly, when the output values of the flip-flops FFZ2 and FFZ3 match at timing of the output value of the AND circuit AZ4 being “1” and the counted value of the 5-bit counter CTR-3 being “5”, the waveform of the reference clock signal −REF_CLK is determined to be fluctuating. Thus, when the output value (+ERR_SYNC_CHK) of the AND circuit AZ8 is “1”, it is determined that an error is generated, and the output value of the synchronization check circuit SYN-1 outputs an error output.

Note that in the example illustrated in FIG. 17, when the output value (+CHK_ENBL) of the AND circuit AZ4 is “1”, and the 5-bit counter CTR-3 count is “5”, the output values of the flip-flops FFZ2 and FFZ3 do not match. Accordingly, the output value +CHK_ENBL of the AND circuit AZ8 is “0”, which indicates “nothing abnormal detected”.

According to the above-described embodiments, various modes or conditions to generate the pseudofault signal may be set in the information processing apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising a sender apparatus and a receiver apparatus connected to the sender apparatus, wherein
the sender apparatus includes
a processor configured to output a plurality of output signals;
a counter configured to send a report indicating that a predetermined time has been counted; and
a pseudofault generator configured to change a value of any one of the output signals output by the processor based on the report sent from the counter, and wherein
the receiver apparatus includes
an error detector configured to detect an error with respect to the changed value of the one of the output signals output by the processor.

2. The information processing apparatus as claimed in claim 1, wherein
the sender apparatus further includes
a storage unit configured to store selecting information on selecting the output signal to be changed by the pseudofault generator from the plurality of the output signals, and wherein
the pseudofault generator changes a value of any one of the output signals output by the processor based on the selecting information stored in the storage unit.

3. The information processing apparatus as claimed in claim 1, wherein
the storage unit further stores output signal change information on a number of times one of the output signals output by the processor is changed by the pseudofault generator, and wherein
the pseudofault generator changes a value of any one of the output signals output by the processor corresponding to the number of times the one of the output signals output by the processor is changed contained in the output signal change information stored in the storage unit.

4. A sender apparatus connected to a receiver apparatus having an error detector to detect an error, the sender apparatus, comprising:
a processor configured to output a plurality of output signals;
a counter configured to send a report indicating that a predetermined time has been counted; and
a pseudofault generator configured to change a value of any one of the output signal output by the processor based on the report sent from the counter.

5. The sender apparatus as claimed in claim 4, further comprising:
a storage unit configured to store selecting information on selecting one of the output signals to be changed by the pseudofault generator, wherein
the pseudofault generator changes a value of the selected one of the output signals output by the processor based on the selecting information stored in the storage unit.

6. The sender apparatus as claimed in claim 5, wherein
the storage unit further stores output signal change information on a number of times one of the output signals output by the processor is changed by the pseudofault generator, and wherein
the pseudofault generator changes a value of the one of the output signals output by the processor corresponding to the number of times the one of the output signals is changed contained in the output signal change information stored in the storage unit.

7. A control method of an information processing apparatus, the information processing apparatus including a sender apparatus and a receiver apparatus connected to the sender apparatus, the control method comprising:
causing a processor contained in the sender apparatus to output a plurality of output signals;
causing a counter contained in the sender apparatus to send a report indicating that a predetermined time has been counted;
causing a pseudofault generator contained in the sender apparatus to change a value of any one of the output signals output by the processor based on the report sent from the counter; and
causing an error detector contained in the receiver apparatus to detect an error with respect to the changed value of the one of the output signals output by the processor.

8. The control method as claimed in claim 7, further comprising:
causing a storage unit to store selecting information on selecting one of the output signals output by the processor to be changed by the pseudofault generator; and
causing the pseudofault generator to change a value of any one of the output signals output by the processor based on the selecting information stored in the storage unit.

9. The control method as claimed in claim 8, further comprising:
causing the storage unit to further store output signal change information on a number of times one of the output signals output by the processor is changed by the pseudofault generator; and
causing the pseudofault generator to change a value of the one of the output signals output by the processor corresponding to the number of times the one of the output signals output by the processor is changed contained in the output signal change information stored in the storage unit.
